(19) United States
(12) Patent Application Publication
(10) Pub. No.: US 2026/0286554 A1
(43) Pub. Date: Sep. 24, 2026

(54) ELECTROLYSER CELL UNIT WITH FLAT SEPARATOR

(71) Applicant: CERES INTELLECTUAL PROPERTY COMPANY LIMITED, Sussex (GB)

(72) Inventors: Zoltan HERCZ, West Sussex (GB); Per HJALMARSSON, West Sussex (GB); Christopher James NOBBS, West Sussex (GB); Duncan Albert Wojciech GAWEL, West Sussex (GB)

(21) Appl. No.: 19/472,275

(22) PCT Filed: Apr. 5, 2024
(86) PCT No.: PCT/GB2024/050919

§ 371 Date: Oct. 3, 2025

(30) Foreign Application Priority Data
Apr. 6, 2023 (GB) 2305181.6

(51) Int. Cl. C25B 13/02; C25B 1/04; C25B 1/23; C25B 9/19; C25B 15/02

(52) U.S. Cl. CPC C25B 13/02; C25B 1/04; C25B 1/23; C25B 9/19; C25B 15/02

(57) ABSTRACT

The present application relates to an electrolyser cell unit having a cell layer (1314) comprising an electrochemically active cell area (1350), the cell layer (1314) having a first side (1315a) and a second side (1315b). The cell unit defines a first fluid flow region (1360) for delivery of fuel to the first side (1315a) of the cell layer (1314) and a second fluid flow region (1365) for exhaust of a fluid from said second side (1315b) of the cell layer (1314). The cross-sectional area of the second fluid flow region (1365) is smaller than the cross-sectional area of the first fluid flow region (1360).

### FIELD OF THE INVENTION

The present invention relates to electrochemical cell units with a flat separator, in particular, fuel cell units and electrolyser cell units, stacks containing such cell units, methods for manufacturing a separator plate (interconnect) for use in such cell units, separator plates so formed, and the use of such cell units. The cell units of the present invention include cells of solid oxide, polymer electrolyte membrane, and molten carbonate types. The present invention more specifically relates to solid oxide fuel cell (SOFC) and solid oxide electrolyser cell (SOEC) units, and these may include metal-supported solid oxide fuel cell (MS-SOFC) or electrolyser cell (MS-SOEC) units.

### BACKGROUND TO THE INVENTION

Some electrochemical cell units can produce electricity by using an electrochemical conversion process that oxidises fuel to produce electricity. Some electrochemical cell units can also, or instead, operate as regenerative fuel cells (or reverse fuel cells) units, often known as electrolyser cell units, for example to produce hydrogen and oxygen from water, or carbon monoxide and oxygen from carbon dioxide. They may be tubular or planar in configuration. Planar electrochemical cell units may be arranged overlying one another in a stack arrangement, for example 100-200 electrochemical cell units in a stack, with the individual electrochemical cell units arranged, for example, electrically in series.

A solid oxide fuel cell (SOFC) that produces electricity is based upon a solid oxide electrolyte that conducts negative oxygen ions from a cathode to an anode located on opposite sides of the electrolyte. For this, a fuel, or reformed fuel, contacts the anode (fuel electrode) and an oxidant, such as air or an oxygen rich fluid, contacts the cathode (air electrode). Conventional ceramic-supported (e.g. anode-supported) SOFCs have low mechanical strength and are vulnerable to fracture. Hence, metal-supported SOFCs have been developed which have the active fuel cell component layer supported on a metal substrate. In these cells, the ceramic layers can be very thin since they only perform an electrochemical function: that is to say, the ceramic layers are not self-supporting but rather are thin coatings/films laid down on and supported by the metal substrate. Such metal supported SOFC stacks are more robust, lower cost, have better thermal properties than ceramic-supported SOFCs and can be manufactured using conventional metal welding techniques.

A solid oxide electrolyser cell (SOEC) may have the same structure as an SOFC but is essentially that SOFC operating in reverse, or in a regenerative mode, to achieve the electrolysis of water and/or carbon dioxide by input of electrical energy and using the solid oxide electrolyte to produce hydrogen gas and/or carbon monoxide and oxygen.

The present invention is directed at an electrochemical cell unit and concerns the design of separator plates for them. It is thus applicable to various types of fuel and electrolyser cells, for example, based on solid oxide electrolytes, polymer electrolyte membranes, or molten electrolytes. For convenience, “cell units” is used to refer to “electrochemical cell units” including fuel or electrolyser cell units.

Each cell unit in a stack of cell units typically includes a cell layer comprising an electrochemically active cell region (such as a metal-supported electrochemically active cell region) and a separator plate. A separator plate typically contacts one side of the cell layer of a cell unit and, in a stack of cell units, and may also contact an opposite side of a cell layer of an adjacent cell unit. A separator plate that, in a stack of cell units, contacts one side of the cell layer of its cell unit and an opposite side of a cell layer of an adjacent cell unit may be referred to as an “interconnect”.

FIG. 1 shows an exploded perspective view of a cell unit with two gaskets, taken from the Applicant's earlier application GB 2603665 A, which discusses an electrochemical cell unit and a stack comprising a plurality of such electrochemical cell units with raised elements. The cell unit 10 of FIG. 1 comprises a flat (i.e. planar) metal support plate 14 stacked next to a separator plate 12. The separator plate 12 is shown to have flanged perimeter 18 around its perimeter. The flanged perimeter 18 extends out of the predominant plane of the sheet, as found at a central fluid volume area, to create a concavity in the separator plate (and a convexity to the outside surface). The concavity will form a fluid volume within this cell unit upon assembly of the cell unit.

In the illustrated arrangement in FIG. 1 the cell unit 10 has rounded ends and parallel sides, with a fluid port 22 towards each end in both the separator plate 12 and the metal support plate 14. Other shapes and sizes and numbers of the respective cell features are possible depending upon the required power and dimensions of the final stack assembly.

Around the fluid ports of the separator plate 12, shaped port features 24 are provided. The shaped port features 24 are provided as multiple elements in the form of round dimples extending out of the plane of the base of the fluid volume a distance corresponding to that of the height of the flanged perimeter 18—to have a common height therewith. This is so that they will contact the opposing surface of the metal support plate 14, just like the flanged perimeter 18, when the cell unit 10 is assembled. As a result, when the flanged perimeter 18 is joined to the metal support plate 14, for example by welding, the shaped port features 24 will likewise contact the metal support plate 14.

In a middle portion of the cell unit 10, an electrochemically active layer 50 is provided on the metal support plate. In this example it is located outside of the enclosed fluid volume.

The electrochemically active area 50 includes an anode, a cathode, and an electrolyte positioned between the anode and cathode (not shown). The anode, electrolyte, and cathode may together be referred to as the electrochemically active layer 50, active electrochemical cell layer, or electrochemically active region. The electrolyte conducts either negative oxygen ions or positive hydrogen ions between the anode and cathode. The stack 20 may comprise a stack of cell units that are based on one of solid oxide electrolytes, polymer electrolyte membranes, or molten electrolytes or any other variant capable of electrochemistry.

The concave configuration can give the relevant plate the appearance of a rimmed tray, with a correspondingly convex outside shape (outside relative to the cell unit) and usually a planar base, the concavity thus defining (e.g. part of) the fluid volume in the assembled cell unit. In this concave configuration, the flanged perimeter extends out of a plane of the original sheet of the separator plate, and/or of the metal support plate, toward a respective opposed surface of the other of the separator plate and the metal support plate.

The fluid volume is thus bordered by a flanged perimeter, which is formed by pressing, such as by use of a die press, hydroforming or stamping. These are simple processes that are already being undertaken in the formation of central protrusions in the fluid volume (described below), as found likewise on the separator plate in the prior art, for supporting and electrically connecting adjacent cells via the electrochemically active layers.

FIG. 2 shows an exploded perspective underside view of the cell unit of FIG. 1. The metal support plate 14 (e.g. metal foil) is provided with multiple small holes or pores 48 to enable fluid in the fluid volume to be in contact with the side of the electrochemical layers that is closest to the metal support plate 14. These form a porous region bounded by a non-porous region. The anode (fuel electrode) layer is located adjacent the small holes/pores with the (enclosed) fluid volume within the cell unit comprising a fuel flow volume supplied by fuel entering and exiting via the fluid ports 22, which are thus fuel ports 22. The cathode (air electrode) layer is on the opposite side of electrochemically active layer 50, i.e. on its outer face, and is exposed to air flowing across that layer during use of the cell unit 10. FIG. 2a shows a simplified cross-section of the arrangement shown in FIGS. 1 and 2.

In the cell units depicted in FIGS. 1 & 2 only two layers (components) are required, i.e. the metal support plate and the separator plate.

There are also provided central upward protrusions 32 and central downward protrusions 36 which include in and out protrusions (up and down as shown), extending between the internal opposed surfaces of the two plates and an outer surface of the electrochemically active layer of the cell unit adjacent to the outward protrusions. The central upward protrusions 32 define fluid pathways between them or in them for fuel, the pathways being through the enclosed fluid volume between fluid ports at each end of the cell unit. The central downward protrusions 36 define fluid pathways between them, or in them for oxidant (such as air) through the fluid volume defined between the outer surface of the electrochemically active layer of the cell unit adjacent to the downward protrusions.

Each gasket, for example gasket 34, (also referred to as a “seal”) provides a primary sealing function and will usually be a compressible gasket that is subjected to high compressive forces in the vicinity of the ports.

The gaskets may be sized to cover all the shaped port features 24 of each fluid port 22 to prevent fluid (such as fuel) that may be travelling through the fluid ports 22 in a stack from seeping between the outside of the cell unit 10 and the gaskets (for example gasket 34), into the area external of the cell units, i.e. into the fluid surrounding the cell units 10 (such as oxidant), or the fluid external of the fluid ports from seeping in the other direction—into the fluid ports. This is important to prevent any mixing of the fluid inside the cell unit 10 and the fluid outside the cell unit 10, which will be fuel and oxidant. The polarity of the electrochemically active layers 50 determines which way round this will be.

The gaskets may also provide electrical insulation between a first cell unit 10 and an adjacent fluid cell unit 10, so as to prevent a short circuit. The gaskets may be any suitable cell gaskets (sealing rings), such as, for example, vermiculite-based gaskets, eg Thermiculite (trade mark).

Cell stacks have various sources of internal resistance. One such source is contact resistance between the separator plate and an adjacent cell layer.

A cell stack may have a top compression plate and a bottom compression plate connected together by bolts or other means to allow cell unit(s) therebetween to be compressed together. The compressive force applied to the stack is sufficient to create a seal to prevent seeping out of the cell unit(s) and/or prevent fluid external of the fluid ports from seeping into the fluid ports.

Compressive forces in the stack within a plan view area of the electrochemically active region are required for good electrical contact and hence good conductivity through the stack. The central upward protrusions 32 and central downward protrusions 36 create the required electrical contacts between cell units and also provide a support function for the cell unit in the central region, extending upwardly to the underside of the metal support plate 14 at the area of the small holes or pores 48, and downwardly to the opposing surface of the electrochemically active layer of a cell below it. In addition, shaped port features 24 around the ports 22 assist in the transfer of compressive forces in the stack at the peripheral ends of each unit cell, to provide the compressive force required to create a seal. There is a need to maintain pressure between the separator plate and the adjacent cell layer to minimize contact resistance between the separator plate and an adjacent cell layer. This is a function of the upward protrusions 32. However, the inclusion of such upward protrusions 32 also has its own disadvantages. For example, the upward protrusions 32 can obstruct holes or pores 48 in the metal support plate 14 and obstruct fuel flow to the electrochemically active cell area. In effect, they detract from efficiency of the cell unit by reducing access of fluid to (and exhaust of product from) the electrochemically active cell region via the pores 48. The skilled person will understand that the electrode fed by the pores 48 is itself adapted to transfer reactant to the electrolyte, and so pores blocked by the protrusions 32 reduce supply to (and exhaust from) the electrochemically active cell region, but do not render the portion of the electrochemically active cell region proximal to a blocked pore inoperable. The upward protrusions 32 also can obstruct to the flow of fluid (such as fuel) across the cell unit, and reduces the capacity of the volume for the flow of said fluid.

The present invention seeks to address, overcome or mitigate at least one of the prior art disadvantages.

### SUMMARY OF THE INVENTION

In a first aspect, there is provided an electrochemical cell unit comprising: a cell layer comprising an electrochemically active cell area, the cell layer having a first side (e.g. lower side) and a second side (e.g. upper side), and a separator plate (e.g. below the cell layer) having a first side (e.g. lower side) and a second side (e.g. upper side), the separator plate comprising a metal sheet, the second side of the separator plate extending across and facing the first side of the cell layer in a spaced arrangement to form a first fluid volume for first fluid therebetween. The separator plate has a region that extends across (e.g. beneath) at least the electrochemically active cell area that is clear or substantially clear of protrusions directed toward the first side of the cell layer (i.e. clear of protrusions protruding into the first fluid volume). This region is substantially free (preferably entirely free) of other components to separate the separator plate from the cell layer. The separator plate is adapted to be exposed to a pressure difference between the first side and the second side of the separator plate to maintain the spaced arrangement that forms the first fluid volume. Preferably, the pressure difference is a fluidic pressure difference, more specifically, gaseous pressure difference.

The second side of the separator plate extends across the first side of the cell layer in an underlying/overlying arrangement. In the figures, the latter overlies the former.

The region that extends across the electrochemically active cell area is entirely or almost entirely flat and largely, almost entirely or entirely free from protrusions or raised features directed toward the first side of the cell layer (of the cell unit of which the separator is a constituent). Such protrusions may include channels, ridges, or dimples and may typically be formed by pressing, etching, or machining. There is no support structure in the first volume to maintain that volume.

The region that extends across the electrochemically active cell area may be coincident with the plan view area (i.e. extent) of the electrochemically active cell area. In other words, the second side of separator does not contact first side of cell layer within the plan view area (i.e. extent) of the electrochemically active cell area and the region is clear of other components to separate the separator plate from the cell layer.

In an operational mode of the electrochemical cell unit, a pressure difference between the first side and the second side of the separator plate (i.e. a positive pressure difference between the first fluid volume and the second fluid volume) maintains or increases a separation between the second side of the separator plate and the first side of the cell layer. In a non-operational mode, when the pressure on each of the first and second sides of the separator plate is the same, the separation may decrease.

Preferably, the architecture of the cell layer is selected from one of the following: metal-supported, anode-supported, electrolyte-supported, or cathode-supported architecture. That is to say the cell layer is one of a metal-supported cell layer, an anode-supported cell layer, an electrolyte-supported cell layer, or a cathode-supported cell layer.

More preferably, the cell layer is a metal-supported cell layer and the first side of the cell layer is a first side of a metal support plate and the second side of the cell layer is a second side of the metal support plate opposite the first side of the metal support plate, the second side carrying the electrochemically active cell area. Furthermore, any mention of a cell layer throughout the description is interchangeable with a cell layer supported by a metal support plate, or a “metal plate supported cell layer” or such like.

The electrochemical cell unit further comprises an inlet to and an outlet from the first fluid volume, preferably positioned towards opposing edges of the cell unit with the electrochemically active cell area positioned therebetween. The inlet to the first fluid volume may be a type of port for the flow of a fluid (such as a reformed fuel) into the first fluid volume formed by the spaced arrangement between the cell layer and the separator plate. The outlet from the first fluid volume also may be a type of port for the flow of a fluid (such as a reformed fuel) into the first fluid volume formed by the spaced arrangement between the cell layer and the separator plate.

The electrochemical cell unit preferably comprises a first plurality of protrusions outwardly extending from the first side of the separator plate, away from the cell layer. The protrusions being raised features or components of the separator plate, either attached or integrally formed with the separator plate. When the protrusions are integrally formed with the separator plate they may be formed through pressing of the separator plate. Preferably, the first plurality of protrusions is in a region that overlies at least the electrochemically active cell area of the cell unit.

The protrusions may have a circular, square, cross, pentagonal, or hexagonal-shaped cross-section. They may also be oval or irregular polygon in cross-section, but ideally should have a lateral-to-vertical aspect ratio less than 10, preferably less than 5, more preferably less than 2. Alternatively or additionally, the length of any protrusion may be less than half of a characteristic lateral dimension (e.g. length, width, or diameter) of the electrochemically active cell region.

One or both of the separator plate and the cell layer of the electrochemical cell unit may also be provided with a second plurality of protrusions (raised features or components) outwardly extending toward and contacting the other of the separator plate and the cell layer at a plurality of contact points on the cell layer surrounding the inlet and the outlet for the flow of fluid to and from the first fluid volume.

The electrochemical cell unit may further comprise a flanged perimeter on at least one of the separator plate and the cell layer. The flanged perimeter may be attached to the separator plate and the cell layer or may be integrally formed with the separator plate and the cell layer by pressing the plate and/or the cell layer. The flanged perimeter may be used to conjoin the separator plate and the cell layer together. For example, the separator plate and the cell layer may be directly adjoined at the flanged perimeter to form the first fluid volume therebetween. The flanged parameter of the separator plate and the cell layer may optionally be welded together, or adjoined directly through some other means.

The electrochemical cell unit may alternatively comprise a spacer plate provided and sandwiched between the separator plate and the metal support plate. The spacer plate may provide a separation between the metal support plate and the separator plate. For example, the spacer plate may be provided and sandwiched between the separator plate and the metal support plate to form the first fluid volume therebetween. Those three plates may be sealingly fixed to one another, for example by welding around their periphery.

The separator plate of the electrochemical cell unit may be configured or otherwise adapted to be exposed to a pressure at the first side of the separator plate that is less than a pressure at the second side of the separator plate. In other words, the separator plate may be configured to be able to survive a dual-pressure environment without becoming irrevocably damaged or distorted. The dual-pressure environment may be supplied to the separator plate by providing fluids of different pressures on the different sides of the separator plate to provide a pressure difference therebetween. When in-situ in a stack of cell unit(s), the separator plate(s) may be configured or otherwise adapted so that in the presence of a pressure difference between its first side and its second side, the first fluid volume formed between the separator plate and the cell layer is maintained.

For example, the pressure of a first fluid on the second side of the separator plate may be greater than that of a second fluid on the first side of the separator plate—the first fluid being a fuel for example, and the second fluid being an oxidant for example.

The pressure difference between the first side and the second side of the separator plate may be controlled by any number of means known to the person skilled in the art. For example, the pressure difference may be established through the use of pumps to pump the fluids at different rates and pressures. Alternatively, or in addition, features such as valves and chokes may be provided in the pipes or flow paths of the first fluid and the second fluid respectively to control the pressure difference between them. The pressure difference between them may be in the range of 50 mbar to 2 bar, preferably between 100 mbar to 1.5 bar, more preferably 200 mbar to 800 mbar. The skilled person will appreciate that the pressure difference used may be tailored to maintain the spacing between the separator plate and the cell layer, and said pressure difference may be dependent on the flexibility of the cell layer and the separator plate (the metal sheet thereof).

By providing features in the flow paths of the first fluid and the second fluid, the initial pressure at the inlet of the first fluid volume and the second fluid volume may be controlled to control the pressure difference between the first fluid volume and the second fluid volume (for fuel cell operation, for electrolysis cell operation only a first fluid may be provided and its initial pressure controlled). Additionally or alternatively, the pressure at the respective outlets of the first fluid volume and second fluid volume may be controlled to provide a pressure difference between the first fluid volume and second fluid volume.

The separator plate may also be configured or otherwise adapted to flex in when it experiences a pressure difference between its first side and its second side. In other words, the pressure difference experienced by the separator plate may be such as to cause the separator plate to flex away from, or toward the cell layer. Preferably, the separator plate may be configured to flex away from the cell layer when exposed to the pressure difference as a positive function of the pressure difference. By flexing away from the cell layer, the spaced arrangement between the separator and the cell layer may be maintained (or increased), and in turn a fluid volume therebetween may be maintained (the height thereof maintained or increased), and contact with an adjacent neighbouring cell unit may be improved.

A cell stack is provided, comprising a plurality of cell units as described above, wherein the second side (e.g. upper side) of the separator plate of a first cell unit faces the first side (e.g. lower side) of a cell layer of the first cell unit in a spaced arrangement to form a first fluid volume for first fluid therebetween, and the first side (e.g. lower side) of the separator plate of the first cell unit faces an electrochemically active cell area of a second, neighbouring, cell unit in the stack of cell units and defines a second fluid volume therebetween.

A cell stack is provided comprising: a plurality of cell units, each cell unit comprising: a cell layer comprising an electrochemically active cell area, the cell layer having a first side and a second side, the second side carrying the electrochemically active cell area; and a separator plate having a first side and a second side, the separator plate comprising a metal sheet, the second (e.g. upper) side of the separator plate underlying and facing the first (e.g. lower) side of the cell layer in a spaced arrangement to form a first fluid volume for first fluid therebetween. The first side of the separator plate extends across and faces an electrochemically active cell area of an adjacent cell unit in the cell stack in a spaced arrangement to form a second fluid volume for second fluid therebetween. The separator plate has a region that extends across at least the electrochemically active cell area, wherein the region is clear of protrusions directed toward the cell layer, or other components to separate the separator plate from the metal support plate. The separator plate is adapted to be exposed to a pressure difference between the first side and the second side of the separator plate to maintain the spaced arrangement that forms the first fluid volume.

The cell stack is configured such that, in operation as a fuel cell, the first fluid volume is for fuel and the second fluid volume is for oxidant. For example, the fuel may be a hydrogen-rich reformate stream (e.g. converted from a hydrocarbon fuel stream such as natural gas). The oxidant may be air or oxygen. In operation as an electrolysis cell, the first fluid volume is for steam.

The cell stack may also be configured such that the first side of the separator plate contacts an outermost layer of the electrochemically active cell area of an adjacent cell unit, providing electrical contact therebetween and having a contact resistance that decreases as the pressure difference between the first side and the second side of the separator plate increases. For example, as described above the pressure difference experienced by the separator plate may be provided by a pressure difference between a pressure of the first fluid in the first fluid volume and a pressure of an oxidant such as air or oxygen on an opposite side of the separator plate i.e. the second fluid volume.

In other words, by introducing a pressure difference either side of the separator plate in one cell unit, the separator plate may be forced to flex toward the electrochemically active area of an adjacent neighbouring cell unit thereby forcing the downward protrusions (or dimples) of the separator plate to come into contact with the electrochemically active area of an adjacent neighbouring cell unit. This flexing can be achieved across the entire active region without extensive protrusions on the other side of the separator plate that would otherwise provide a force in that direction. By bringing the downward protrusions into contact with the electrochemically active area of an adjacent neighbouring cell unit the contact resistance decreases, i.e. conductivity through the stack is improved.

In this manner, the separator plate is adapted to be exposed to a pressure difference between the first side and the second side of the separator plate to maintain the spaced arrangement that forms the first fluid volume.

(To the extent that there may be protrusions on the second side of the separator plate (over a minority of the area thereof, e.g. 10% or 20%), such protrusions may be caused to separate under pressure from the first side of the metal support plate, lifting away from the holes/pores therein and permitting fuel access to the porous region of the support plate. Note also that, even if a few protrusions are provided on the second side of the separator plate, they are fewer in number than on the first side. Fluid pressure will give even pressure across the plate, obviating the need for protrusions on the second side across the entirety of the active region).

A method for manufacturing a cell unit is provided. The method comprises: providing a planar metal sheet for a separator plate having a first side and a second side, the planar metal sheet having protrusions; providing a cell layer comprising an electrochemically active cell area, the cell layer having a first side and a second side; and overlying the separator plate and the cell layer such that the separator plate faces the first side of the cell layer in a spaced arrangement to form a first fluid volume therebetween and the separator plate has a region that extends across at least the electrochemically active cell area. The region is clear of protrusions directed toward the cell layer or other components to separate the separator plate from the cell layer.

The method may comprise providing a metal support plate with a cell layer comprising an electrochemically active cell area, wherein the first side of the cell layer is a first side of a metal support plate and the second side of the cell layer is a second side of the metal support plate opposite the first side of the metal support plate, the second side carrying the electrochemically active cell area. The method may comprise pressing the planar metal sheet to provide the planar protrusions extending from the surface of the planar metal sheet

At least one of the separator plate and the cell layer (or the metal support plate supporting a cell layer) may be processed to form a flanged perimeter. The flanged perimeter of the separator plate and/or the cell layer (or the metal support plate supporting a cell layer) may be integrally formed with the separator plate and/or the cell layer (or the metal support plate supporting a cell layer) by pressing. During manufacture, the separator plate and the cell layer may be directly adjoined at the flanged perimeter to form the first fluid volume therebetween, optionally by welding.

As an alternative to a flanged perimeter (or in addition), a spacer plate may be provided between the separator plate and the metal support plate. The spacer plate may extend around the perimeter of the separator plate and/or the cell layer. It may serve to space the plates apart and define the first fluid volume.

A method for manufacturing a cell unit stack is provided. The method comprises: providing a plurality of cell units, each cell unit manufactured as described above and overlaying/underlying one of the plurality of cell units with another one of the plurality of cell units such that the protrusions of the separator plate of the one of the plurality of cell units extend and come into contact with an electrochemically active cell area of another one of the plurality of cell units. The overlaying/underlying further comprises providing gaskets between the one of the plurality of cell units and the other one of the plurality of cell units.

A method of operating a cell stack of cell units is provided. The cell stack is as described above and the method comprises: providing a first fluid to the first fluid volume; providing a second fluid to the second fluid volume; and regulating a pressure difference between the first fluid volume and the second fluid volume to maintain the spaced arrangement that forms the first fluid volume.

In one aspect of the present invention there is provided a method of operating a cell stack of cell units is provided. In the method, each cell unit in the cell stack comprises: a cell layer comprising an electrochemically active cell area, the cell layer having a first side and a second side; a separator plate electrically connected to the cell layer, the separator plate having a first side and a second side, the second side of the separator plate extending across and facing the first side of the cell layer in a spaced arrangement to form a first fluid volume and, the first side of the separator plate comprising protrusions directed away from the first side of the cell layer and towards a second side of a cell layer of a neighbouring cell unit to form a second fluid volume. The method comprises: providing a first fluid to the first fluid volume; providing a second fluid to the second fluid volume; and regulating a pressure difference between the first fluid volume and the second fluid volume to maintain a spaced arrangement that forms the first fluid volume. In such a way, an electrical connection between the protrusions and the second side of the cell layer of the neighbouring cell unit can be controlled by the pressure difference.

In another aspect of the invention there is provided an electrochemical cell unit comprising: a cell layer comprising an electrochemically active cell area, the cell layer having a first side and a second side; a separator plate electrically connected to the cell layer, the separator plate having a first side and a second side, the second side of the separator plate extending across and facing the first side of the cell layer in a spaced arrangement to form a first fluid volume and, the first side of the separator plate comprising protrusions directed away from the first side of the cell layer and towards a second side of a cell layer of a neighbouring cell unit, wherein the separator plate is adapted to be exposed to a pressure difference between the first side and the second side of the separator plate to maintain the spaced arrangement that forms the first fluid volume and to bias the protrusions towards the second side of the cell layer of the neighbouring cell unit. In such a way, an electrical connection between the protrusions and the second side of the cell layer of the neighbouring cell unit can be controlled by the pressure difference.

In another aspect of the invention there is provided a method for manufacturing a cell stack comprising a plurality of electrochemical cell units, comprising: providing a plurality of cell units, each cell unit comprising a cell layer comprising an electrochemically active cell area, the cell layer having a first side and a second side, and a separator plate electrically connected to the cell layer, the separator plate having a first side and a second side, the second side of the separator plate extending across and facing the first side of the cell layer in a spaced arrangement to form a first fluid volume, the first side of the separator plate comprising protrusions directed away from the first side of the cell layer; and overlaying the plurality of cell units one upon another so that the first side of the separator plate of a first cell unit faces the second side of a second, neighbouring, cell unit in the stack of cell units and defines a second fluid volume therebetween, wherein said protrusions in the separator plate of the first cell unit are directed towards a second side of a cell layer of a neighbouring cell unit, and wherein the separator plate of the first cell unit is adapted to be exposed to a pressure difference between the first side and the second side of the separator plate to maintain the spaced arrangement that forms the first fluid volume and to bias the protrusions towards the second side of the cell layer of the neighbouring cell unit.

Note that where the cell units are electrolysis cell units, the second fluid is generated in the reaction. In other words, the steps of providing encompass providing (from a source external to the cell units) initial reactant and providing (or generating, by the cell units) product of the electrochemical reaction at the cell units. For example, in electrolysis cell operation the first fluid volume of the cell units is provided with fuel (in the form of steam from a source external to the cell units) and a product of the electrolysis reaction, that product being hydrogen if the electrolyte is oxygen ion conducting or oxygen if the electrolyte is hydrogen ion conducting. Correspondingly, the second fluid volume of the cell units may only be provided with a product of the electrolysis reaction, that product being (in the example of steam as a fuel) oxygen if the electrolyte is oxygen ion conducting or hydrogen if the electrolyte is hydrogen ion conducting. A sweep gas (e.g., oxygen or air) may optionally be provided to the second fluid volume from a source external to the cell units. Such sweep gas may assist in exhausting product of the electrolysis reaction from the second fluid volume.

The methods of operating the cell stack may comprise: providing a fuel (e.g., a reformed hydrocarbon fuel or hydrogen in fuel cell operation, or steam in electrolysis cell operation, and product of said reaction) to a fuel volume of the each cell unit of the cell stack, the fuel volume of each cell unit formed between a respective separator plate and respective cell layer of each cell unit; providing air or oxygen (from a source external to the cell units in fuel cell operation, and as a product of the reaction or as a sweep gas in electrolysis cell operation) to an oxidant fluid volume of the each cell unit of the cell stack, the oxidant fluid volume of each cell unit formed between cell units of the cell stack; and regulating a pressure difference between the fuel volume and the oxidant volume by regulating the pressure of the reformed hydrocarbon fuel and the pressure of the air or oxygen respectively.

The pressure difference between the first fluid volume and the second fluid volume may be regulated to be in the range of 50 mbar to 2 bar, preferably between 100 mbar to 1.5 bar, more preferably 200 mbar to 800 mbar.

The pressure difference is preferably regulated to decrease an electrical contact resistance between the separator plate and the electrochemically active cell area of the second, neighbouring, cell unit in the stack of cell units. By increasing the pressure difference, the electrical contact resistance may be decreased, thereby improving efficiency of the stack.

The pressure difference may be regulated by, for example, i) the use of pumps for the pumping of the first fluid and the second fluid at different rates ii) chokes such as valves, or convergent-divergent nozzles (such as a de Laval nozzles) in a pipe or flow path providing the fluids to a first fluid inlet and a second fluid inlet of the cell units and/or the cell stack as a whole, iii) orifice plates in the pipe or flow path to assist in the regulation of the pressure difference between the first fluid and the second fluid. Other ways and apparatus that may be used to establish a pressure difference between the first fluid and the second fluid will be readily known by the person skilled in the art.

In a further aspect, there is provided an electrolyser cell unit comprising: a cell layer comprising an electrochemically active cell area, the cell layer having a first side and a second side; a first fluid flow region for delivery of fuel to the first side of the cell layer; and a second fluid flow region for exhaust of a fluid from said second side of the cell layer. The cross-sectional area of the second fluid flow region may be smaller than the cross-sectional area of the first fluid flow region. The cell layer may be self-supporting. References to the first (second) side of the cell layer are interchangeable with a first (second) side of the electrochemically active cell area, except where context dictates otherwise, since the first (second) side of the electrochemically active cell area bounds the first (second) fluid flow region. In some cases the electrochemically active cell area is supported by a (e.g., metal) support plate in which case one side (typically the first side) of the electrochemically active cell area is supported by one side (typically a second side) of the support plate and the other side (typically first side) of the support plate may be considered the first side of the cell layer.

It has been found that reducing the relative volume of the exhaust side (the second fluid flow region) to the fuel side (the first fluid flow region) has many benefits, including:
Simpler separator design and manufacturing
Higher volumetric power density (more cells per unit volume and smaller stack for same power)
Avoid potentially damaging the separator plate when pressing the same, including potentially damaging protective layers on the same
Repeat unit flatness more consistent
Faster turn-around time in development
Improved electrical contact
Avoid local fuel starvation by better current distribution

Cell units having substantially symmetrical separator plate designs are known, and it is desirable that an electrolyser cell unit can be easily run in reverse as a fuel cell unit and vice-versa. Fuel cell units require cooling, and that cooling is often achieved by providing additional oxidant (additional to that for use in the fuel cell reaction) as a coolant.

The claimed invention identifies that the coolant volume used in cell units (provided for operation as a fuel cell) is not needed for reverse operation as an electrolyser cell unit. By providing an electrolyser cell unit in which the cross-sectional area of the second fluid flow region is smaller than the cross-sectional area of the first fluid flow region, higher volumetric power density can be achieved for an electrolyser cell unit. The relatively reduced size required for the second fluid flow region in turn allows for different means to achieve the second fluid flow region which may reduce complexity in design and manufacture relative to pressed or formed dimples typically used. The relatively reduced flow rate required in the second fluid flow region and/or means used to achieve the second fluid flow region mean that the contact area between the first side of the separator plate and the second side of the cell layer can be increased (relative to using formed or pressed dimples and/or relative to having a larger flow rate in the second fluid flow region) thereby decreasing contact resistance between said components and improving power density of cell units and stacks thereof.

The first fluid flow region may also be for exhaust of a first product of the electrolysis reaction, that first product produced at the first side of the electrochemically active cell area. The fluid exhausted from said second side of the electrochemically active cell area may be a second product of the electrolysis reaction, that second product produced at the second side of the electrochemically active cell area. The second fluid flow region may be further for circulation (i.e. delivery and exhaust) of a sweep gas to assist in exhaust of the fluid from said second side of the electrochemically active cell area (i.e., exhaust of the second product of the electrolysis reaction). The flow rate of that sweep gas (and cross-sectional area required therefor) may be three times, preferably 5 times, more preferably ten times lower than the flow rate of fuel.

The electrolyser cell unit preferably comprises a separator plate having a first side and a second side, the second side of the separator plate overlying and facing the first side of the cell layer in a spaced arrangement to form the first fluid flow region. In this case, the second fluid flow region may be defined by a region between the second side of the cell layer and a first side of a separator plate of an adjacent electrolyser cell unit. Such an arrangement may be relatively simple to manufacture, and may reduce resistance in a stack of cell units since each cell unit may be at the same potential.

Alternatively, the electrolyser cell unit comprises a separator plate having a first side and a second side, the first side of the separator plate overlying and facing the second side of the cell layer in a spaced arrangement to form the second fluid flow region. In this case the first fluid flow region may be defined by a region between the first side of the cell layer and a second side of a separator plate of an adjacent electrolyser cell unit. Such an arrangement may result in the electrochemically active cell area being enclosed within and protected by the cell unit.

The second fluid flow region may be defined by the topology of a layer on the first side of the separator plate. This means that the separator plate need not be deformed to provide the second fluid flow region. In other words, the features which define the second fluid flow region are not pressed or formed features. Said features define the second fluid flow region and transfer the stack compression force through the stack to provide good electrical contact between the second side of the cell layer and the second side of the separator plate. This simplifies manufacture of the separator plate, and reduces stresses in the separator plate from manufacture of the same and improves reliability of the cell units. It also results in a large contact area between the first side of the separator plate and the cell layer, reducing contact resistance therebetween, thereby improving efficiency of the cell units.

The first side of the separator plate may be provided with features deposited or printed thereon to form the second fluid flow region. Depositing or printing features to form the second fluid flow region is cost effective, quick, and produces features having consistent height.

The first side of the separator plate may be provided with features formed in a layer thereon to form the second fluid flow region. In some cases, it may be preferable to remove material from a layer on the first side of the separator plate to form the second fluid flow region. The layer may be deposited or printed as a homogeneous layer, which is quick and repeatable. The features may then be formed by selective removal of parts of the layer, for example by etching or machining.

The features provided on the first side of the separator plate may comprise at least one of:
a plurality of ribs extending from the second side of the separator toward the first side of the cell layer;
a plurality of discrete protrusions extending from the second side of the separator toward the first side of the cell layer; or
a porous layer.

In each case, the peak(s) of the features contact the first side of the cell layer in the cell units and/or in a stack of cell units. This enables good electrical contact and even transmission of compression through the stack. In other words, peaks of the discrete protrusions or ribs form a plane which intersects with the first side of the cell layer. The discrete protrusions may comprise a material supported or coated upon the first side of the separator plate, in contrast to pressed or formed dimples. The porous layer is preferably homogeneous in thickness and porosity to promote good electrical contact and even transmission of compression through the stack. This simplifies manufacture of the separator plate and reduces stresses in the separator plate from manufacture of the same and improves reliability of the cell units. It also results in a large contact area between the first side of the separator plate and the cell layer, reducing contact resistance therebetween, thereby improving efficiency of the cell units.

The separator plate may have a region that overlies at least part of the electrochemically active cell area that is planar and that region having no pressed or formed protrusions directed away from the first side of the cell layer. In other words, the separator plate need not be bent in said direction in said region. This may improve integrity of the separator plate and lifetime of the electrolyser cell unit. Preferably, the separator plate is formed from a sheet (e.g., a metal sheet), and it is that sheet which has a region that overlies at least part (optionally all) of the electrochemically active cell area that is planar and that region having no pressed or formed protrusions (also referred to as dimpled protrusions or dimples) directed away from the first side of the cell layer (toward the second side of the cell layer). This reduces stresses in the separator plate from manufacture of the same and improves reliability of the cell units. It also results in a large contact area between the first side of the separator plate and the cell layer, reducing contact resistance therebetween, thereby improving efficiency of the cell units.

The separator plate may have a region that overlies at least part of the electrochemically active cell area that is provided with a plurality of pressed or formed protrusions directed toward the first side of the cell layer to form the first fluid flow region, those pressed or formed protrusions outwardly extend from the second side of the separator plate, thereby forming convex protrusions on said second side of the separator plate and concave depressions on the first side of the separator plate.

These pressed or formed protrusions transfer compression through the stack, to promote good electrical contact between the second side of the cell layer and first side of the separator plate (i.e. between adjacent or within cell units).

Alternatively, the separator plate may be provided with a plurality of pressed or formed ribs extending from the second side of the separator plate toward the first side of the cell layer to form the first fluid flow region, wherein the corresponding concave side of each rib forms a channel on the first side of the separator plate to form the second fluid flow region. In this case manufacture of the separator plate is simplified and costs reduced by one feature produced in the pressing/forming step providing both the first and second fluid flow regions.

Preferably, the pressed or formed ribs are longer than the length of the electrochemically active cell area such that the concave side of each rib is configured to exhaust second fluid (i.e. a product of the electrolysis reaction) from the second side of the cell layer with low pressure drop. In other words, one end of ribs may protrude (in the length direction of the ribs) past at least one end of the electrochemically active cell area. Preferably, each end of the ribs protrudes (in the length direction of the ribs) past opposing ends of the electrochemically active cell area. This may enable both ends of each of the ribs to exhaust second fluid (i.e. a product of the electrolysis reaction) from the second fluid flow region, or alternatively enable use of a sweep gas in the second fluid flow region, provided at one end of each of the ribs and exhausted (with product of the electrolysis reaction) at the opposite end of each of the ribs. The ribs may be adapted to contact the first side of the cell layer, e.g., at a peak of the convex side of each of the ribs (on a second side of the separator plate).

The separator plate may have a region that overlies at least part of the electrochemically active cell area that is provided with a plurality of pressed or formed protrusions directed toward the first side of the cell layer, and the concave side of each rib fluidically connects (concave sides of) the protrusions. In such cases, the ribs and the protrusions (specifically, the concave sides thereof) thereby form the second fluid flow region. The ribs may connect a protrusion to its nearest neighbours (i.e., a given protrusion provided with a plurality of ribs, a rib to connect it to each of its nearest neighbours). The ribs may connect protrusions from one end of the cell unit to a protrusion at an opposing end of the cell unit, optionally with ribs from protrusions at one or both ends which extend to pass an edge of the electrochemically active cell area, and are referred to as interconnected ribs. The interconnected ribs (network of protrusions and ribs therebetween) have an extent which is longer than the length of the electrochemically active cell area such that the interconnected ribs are configured to exhaust second fluid (i.e. a product of the electrolysis reaction) from the second side of the cell layer with low pressure drop. In other words, one end of each interconnected rib may protrude (in the length direction of the ribs) past at least one end of the electrochemically active cell area. Preferably, each end of the interconnected ribs protrudes (in the length direction of the ribs) past opposing ends of the electrochemically active cell area. This may enable both ends of each of the interconnected ribs to exhaust second fluid (i.e. a product of the electrolysis reaction) from the second fluid flow region, or alternatively enable use of a sweep gas in the second fluid flow region, provided at one end of each of the interconnected ribs and exhausted (with product of the electrolysis reaction) at the opposite end of each of the interconnected ribs. The interconnected ribs may also interconnect with one or more fluid ports for supply and/or exhaust of the second fluid flow region.

The protrusions may be adapted to contact the first side of the cell layer and the (convex side of the) ribs are not adapted to contact the first side of the cell layer. In other words the protrusions may have a greater height than the ribs. This means that the protrusions define the first fluid flow region while the ribs do not block flow within the first fluid flow region. The ribs nevertheless define the second fluid flow region and allow fluidic communication therein.

The separator plate may additionally or alternatively have a region that extends across at least the electrochemically active cell area, and wherein the region is clear of protrusions (i.e. pressed or formed protrusions, also referred to as dimples) directed toward the cell layer or other components to separate the separator plate from the cell layer. In other words, the separator plate is entirely flat (over its whole area or within the plan view area that extends across at least the electrochemically active cell area). Preferably, the separator plate comprises a metal sheet, and that metal sheet is flat (planar) within the region. In such cases, the separator plate may be adapted to be exposed to a pressure difference between the first side and the second side of the separator plate to maintain the spaced arrangement that forms the first fluid flow region. The region that extends across the electrochemically active cell area is entirely or almost entirely flat and largely, almost entirely or entirely free from protrusions or raised features directed toward the first side of the cell layer (of the cell unit of which the separator is a constituent). In this case, there is no support structure in the first volume to maintain that volume (including the fluid flow region).

In an operational mode of an electrochemical cell unit, a pressure difference between the first side and the second side of the separator plate (i.e. a positive pressure difference between the first fluid flow region/first fluid volume and the second fluid flow region/second fluid volume) may maintain or increase a separation between the second side of the separator plate and the first side of the cell layer. In a non-operational mode, when the pressure on each of the first and second sides of the separator plate is the same, the separation may decrease.

The pressure difference between the first side and the second side of the separator plate may be controlled by any number of means known to the person skilled in the art. For example, the pressure difference may be established through the use of pumps to pump the fuel at different rates and pressures. Alternatively, or in addition, features such as valves and chokes may be provided in the pipes or flow paths of the fuel to control the pressure difference first side and the second side of the separator plate. The pressure difference between first side and the second side of the separator plate may be in the range of 50 mbar to 2 bar, preferably between 100 mbar to 1.5 bar, more preferably 200 mbar to 800 mbar. The skilled person will appreciate that the pressure difference used may be tailored to maintain the spacing between the separator plate and the cell layer (e.g., at a desired value, and/or to maintain the contact resistance at a desired value, whereby increasing the pressure difference decreases the contact resistance), and said pressure difference may be dependent on the flexibility of the cell layer and the separator plate (the metal sheet thereof).

The first fluid flow region may be defined by the topology of a layer on the second side of the separator plate. This means that the separator plate and the cell layer are flat, and need not be deformed to provide the first fluid flow region. In other words, the features which define the first fluid flow region are not pressed or formed features. Said features define the first fluid flow region and transfer the stack compression force through the stack to provide good electrical contact between the second side of the cell layer and the second side of the separator plate.

The second side of the separator plate may comprise features deposited thereon to form the first fluid flow region. Depositing or printing features to form the second fluid flow region is cost effective, quick, and produces features having consistent height. Such deposition of the features may ensure cleanliness and reduce processing steps. The features may be deposited by screen printing or ink jet printing.

Alternatively or additionally, the second side of the separator plate may comprise features formed therein to form the second fluid flow region. In such a case, the features may be created by partial removal of a layer first deposited or printed on the second side of the separator plate. The layer may be deposited or printed as a homogeneous layer, which is quick and repeatable. The features may then be formed by selective removal of parts of the layer, for example by etching or machining. In some cases, such homogeneous layers may already be present on the second side of the separator plate (e.g., protective layers), and part of such layer may be removed, this may reduce processing steps and reduce the number of different layers and materials in a cell unit.

The features provided on the second side of the separator plate may include at least one of:
a plurality of ribs extending from the second side of the separator toward the first side of the cell layer;
a plurality of discrete protrusions extending from the second side of the separator toward the first side of the cell layer; or
a porous layer.

A plurality of discrete protrusions (similar to the abovementioned discrete protrusions) may also be provided around ports through the cell layer (metal support plate), separator plate, and spacer plate if used, to allow fluidic communication between the ports and the fluid volume enclosed within the cell unit (e.g., between the first side of the cell layer and the second side of the separator plate, or between the second side of the cell layer and the first side of the separator plate).

The second fluid flow region may be defined by the topology of a layer on the second side of the cell layer, preferably on the second side of the electrochemically active cell area. This means that the separator plate need not be deformed to provide the second fluid flow region. In other words, the features which define the second fluid flow region are not pressed or formed features. Said features define the second fluid flow region and transfer the stack compression force through the stack to provide good electrical contact between the second side of the cell layer and the second side of the separator plate.

The topology of the layer on the second side of the cell layer, preferably on the second side of the electrochemically active cell area, may comprise features deposited thereon to form the second fluid flow region. Such deposition of the features may ensure cleanliness and reduce processing steps. The features may be deposited by by screen printing or ink jet printing.

Alternatively, the topology of the layer on the second side of the cell layer, preferably on the second side of the electrochemically active cell area, may comprise features formed therein to form the second fluid flow region. In other words, the features may be formed in an outermost layer (e.g., the cathode or the anode) of the electrochemically active cell area, for example by etching or machining. This may reduce processing steps and reduce the number of different layers and materials in a cell unit.

The features formed on or in the second side of the cell layer, preferably on the second side of the electrochemically active cell area may comprise at least one of:
a plurality of ribs on the second side of the cell layer, preferably on the second side of the electrochemically active cell area; or
a plurality of discrete protrusions on the second side of the cell layer, preferably on the second side of the electrochemically active cell area.

The discrete protrusions are similar to those that may be provided on the separator plate. The ribs are provided in a similar manner to the discrete protrusions. Neither the discrete protrusions nor the ribs constitute channels, and so do not restrict flow in the second fluid flow region.

Alternatively, the features which form the second fluid flow region comprise a porous layer. Said porous layer may be coated or deposited on the second side of the cell layer, preferably on the second side of the electrochemically active cell area, or may be self-supporting. Use of a layer in which no patterning is required may reduce the number of processing steps.

Preferably, a ratio between the cross-sectional area of the second flow region and the cross-sectional area of the first flow region is 1:3 or lower, optionally 1:10 or lower. Said ratio may be greater than 1:25, optionally greater than 1:20. This increases the power density of the cell units, by providing cell units having smaller heights.

Preferably, a height of the second fluid flow region is smaller than a height of the first fluid flow region. This increases the power density of the cell units, by providing cell units having smaller heights. Such height difference may result in the cross-sectional area of the second fluid flow region being smaller than the cross-sectional area of the first fluid flow region (and may assume that the plane view area (length and width) of the cell unit is typically similar or the same for the first fluid flow region and the second fluid flow region.

The height of the second fluid flow region may be at least 3, preferably at least 10, times smaller than the height of the first fluid flow region. Said height may be at most 25, optionally at most 20, times smaller than the height of the first fluid flow region.

The electrolyser cell unit may be adapted such that a ratio between flow rate of fluid in the second fluid flow region and the flow rate of fluid in the first fluid flow region the first flow region is 1:3 or higher, optionally 1:10 or higher. Said ratio of flow rates may be at most 1:25, optionally at most 1:20.

The electrochemically active cell area may comprise an oxygen ion conducting electrolyte and the second fluid flow region is for exhaust of oxygen from the second side of the cell layer, preferably from the second side of the electrochemically active cell area. For example, the electrolyser cell unit may be a Solid Oxide Electrolyser Cell, SOEC. The fuel may be water, preferably in the form of steam, in which case hydrogen is produced at the first side of the electrochemically active cell area and exhausted therefrom (along with any unused water) by the first fluid flow region. In this case, oxygen is produced at the second side of the electrochemically active cell area and exhausted therefrom (along with any sweep gas which is also provided) by the second fluid flow region. Fuels other than water may be used, for example carbon dioxide in which case carbon monoxide is produced at the first side of the electrochemically active cell area and exhausted therefrom (along with any unused carbon dioxide) by the first fluid flow region. In this case, oxygen is produced at the second side of the electrochemically active cell area and exhausted therefrom (along with any sweep gas which is also provided) by the second fluid flow region.

Alternatively, the electrochemically active cell area may comprise a proton conducting electrolyte and the second fluid flow region is for exhaust of hydrogen from the second side of the cell layer, preferably from the second side of the electrochemically active cell area. For example, the electrolyser cell unit may be a Proton Exchange Membrane Electrolyser Cell, PEMEC. The fuel may be water in which case oxygen is produced at the first side of the electrochemically active cell area and exhausted therefrom (along with any unused water) by the first fluid flow region. In this case, hydrogen is produced at the second side of the electrochemically active cell area and exhausted therefrom (along with any sweep gas which is also provided) by the second fluid flow region Fuels other than water may be used.

Preferably, the first side of the cell layer is a cathode of the electrochemically active cell area and/or the second side of the cell layer is an anode of the electrochemically active cell area.

An architecture of the cell layer may be selected from one of the following: metal-supported, anode-supported, electrolyte-supported, or cathode supported architecture.

Preferably, the cell layer is a metal-supported cell layer comprising the electrochemically active cell area supported by a metal support plate. The metal support plate may have a first side and a second side, the first side of the electrochemically active cell area (preferably the fuel electrode, e.g., cathode for electrolyser operation) being supported (or carried) by the second side of the metal support plate, and the second side of the separator plate overlying and facing the first side of the metal support plate in a spaced arrangement to form the first fluid flow region therebetween. A porous region may be provided in the metal support plate for fluidic communication between the first side of the metal support plate and the first side of the electrochemically active cell area.

One or both of the metal support plate and separator plate may be provided with a flange (e.g., around the perimeter of one or each plate), and the electrolyser cell unit may be sealed around the flange by a weld between the two plates to enclose either the first fluid flow region or the second fluid flow region. When so enclosed, the first fluid flow region forms the first fluid volume and the second fluid flow region forms the second fluid volume. The metal support plate and separator plate abut (i.e. are in contact with) one another around the flange. The flange in a first of the metal support plate and separator plate extends toward the other one of metal support plate and separator plate (and vice-versa if both components are provided with a flange).

Alternatively (to the flange) a spacer plate may be provided between the metal support plate and separator plate, and the electrolyser cell unit is sealed around the perimeter of said plates to enclose either the first fluid flow region or the second fluid flow region. Optionally, the electrolyser cell unit is sealed around the perimeter of said plates by a weld through the spacer plate, metal support plate and separator plate to enclose either the first fluid flow region or the second fluid flow region. The spacer may comprise a frame or flat peripheral component (positioned beyond the electrochemically active cell area) that is sandwiched between the metal support plate and separator plate and that creates a volume for, and sealingly surrounds, the fluid flow region or volume (e.g. the first fluid flow region/volume) that is enclosed by said plates.

According to an aspect, an electrolyser cell unit is provided characterized in that the exhaust volume is smaller than the fuel volume. For example, an electrochemically active cell area of the electrolyser cell unit may have an electrolyte which conducts oxygen ions, in such a case the fuel may be water, provided to a first side of the electrochemically active cell area and the exhaust volume may be for oxygen generated at a second side of the electrochemically active cell area. The fuel volume may also exhaust hydrogen generated at the first side of the electrochemically active cell area.

According to a further aspect, an asymmetric separator plate for an electrolyser cell unit is provided.

According to a further aspect an electrolyser cell unit is provided. That electrolyser cell unit comprising a metal support plate having a first side and a second side, the second side carrying an electrochemically active cell area; and a separator plate having a first side and a second side, the second side of the separator plate overlying and facing the first side of the metal support plate in a spaced arrangement to form a first fluid volume for first fluid therebetween. The separator plate has a region that overlies at least part (optionally the whole extent) of the electrochemically active cell area that is planar and that region having no protrusions directed away from the metal support plate, the electrolyser cell unit comprising a fluid flow region for a second fluid, the fluid flow region forming part of one or both of:
an outermost layer of the electrochemically active cell area, the fluid flow region for delivery and/or exhaust of the second fluid to/from the outermost layer of the electrochemically active cell area, and
the first side of the separator plate, the fluid flow region for delivery and/or exhaust of the second fluid to/from an outermost layer electrochemically active cell area of an adjacent electrolyser cell unit.

Delivery of second fluid may include delivery of a sweep gas to said fluid flow region.

According to a further aspect an electrolyser cell unit is provided, the electrolyser cell unit comprising: a metal support plate having a first side and a second side, the second side carrying and electrochemically active cell area; and a separator plate comprising a metal sheet having a first side and a second side, the second side of the metal sheet overlying and facing the first side of the metal support plate. In such a case, the metal sheet may have a region that overlies at least part (optionally the whole extent) of the electrochemically active cell area that is planar, having no protrusions on the first side directed away from the metal support plate; the electrolyser cell unit comprising a fluid flow region which overlies the first side of the metal sheet; the fluid flow region comprising a mesh; and the fluid flow region for delivery of first fluid to an outermost layer of the cell chemistry layers.

A kit of parts may be provided. The kit of parts may comprise two or more electrolyser cell units according to any one of claims 2 to 33 being adapted to be stacked together. The kit of parts may further comprise a gasket to surround each fluid port provided through the electrolyser cell units.

Preferably, at least one fluid port, usually at least one inlet port and at least one outlet port, is provided as an opening through each of the cell layer (e.g., metal support plate thereof) and the separator plate, the respective fluid ports being aligned with each other in the direction of stacking and in communication with the fluid flow region (fluid volume) enclosed within cell unit.

Preferably, at least the separator plate (and, if present, and then optionally additionally or alternatively the metal support plate), is provided with shaped port features formed around its port that extend inwardly within the fluid volume enclosed within the cell unit, elements of the shaped port features being laterally spaced from one another to define fluid pathways between the elements from the port to enable passage of fluid from the port to the enclosed fluid volume and the fluid flow region. The shaped port features may be dimpled protrusions preferably formed by pressing—and may be pressed at the same time as any flanged perimeter. Alternatively to dimpled protrusions, the shaped port features may be discrete protrusions. The shaped port features transfer compression force through the cell unit for use in compressing gaskets (surrounding and sealing ports) between adjacent cell units.

An electrolyser cell stack is provided. The electrolyser cell stack comprising a plurality of electrolyser cell units according to the above, the electrolyser cell units being stacked one upon another, wherein adjacent electrolyser cell units are electrically connected by the fluid flow region therebetween.

A method for manufacturing an electrolyser cell unit is provided. The method comprises: providing (optionally, providing a planar metal sheet for) a separator plate having a first side and a second side; providing a cell layer comprising an electrochemically active cell area, the cell layer having a first side and a second side; and overlying the separator plate and the cell layer such that the second side of the separator plate overlies and faces the first side of the cell layer. The cell layer and/or the separator plate provide a first fluid flow region for delivery of fuel to the first side of the cell layer (e.g., a first side of the electrochemically active area) and a second fluid flow region for exhaust of a fluid from said second side of the cell layer (e.g., a second side of the electrochemically active area), wherein the cross-sectional area of the second fluid flow region is smaller than the cross-sectional area of the first fluid flow region.

The method may further comprise processing at least one of the separator plate (e.g., the planar metal sheet thereof) and the cell layer to form the second fluid flow region, the second fluid flow region formed by:
printing or depositing a material forming the second fluid flow region onto one or both of:
   an outermost layer of the electrochemically active cell area, the second fluid flow region for exhaust of fluid from the outermost layer of the electrochemically active cell area; and
   a side of the separator plate (e.g., planar metal sheet thereof), the second fluid flow region for exhaust of fluid from an outermost layer of electrochemically active cell area of an adjacent electrolyser cell unit;
or
patterning an outermost layer of the electrochemically active cell area, the second fluid flow region for exhaust of fluid from the outermost layer of the electrochemically active cell area.

The method may further comprise providing the cell layer by providing a metal support plate upon which the electrochemically active cell area is supported, and wherein overlying the separator plate and the cell layer further comprises overlying the separator plate and the metal support plate. Optionally, the method comprises directly joining the metal support plate and separator plate around their perimeter (e.g. at a flanged provided around the perimeter of at least one of the plates).

Alternatively, the method also involves providing a spacer plate, positioning the spacer plate between the separator plate and the metal support plate, and joining the separator plate, the spacer plate and the metal support plate around their perimeter, preferably by welding through the three plates.

According to an alternative aspect, a method for manufacturing an electrolyser cell unit is provided, the method comprising:
providing (optionally, a planar metal sheet for) a separator plate having a first side and a second side
providing a metal support plate having a first side and a second side, the second side carrying an electrochemically active cell area;
processing at least one of the separator plate (e.g., planar metal sheet thereof) and the metal support plate to form a fluid flow region by
   printing or depositing a material forming the fluid flow region onto one or both of:
      an outermost layer of the cell chemistry layers, the fluid flow region for delivery of fluid to the outermost layer of the electrochemically active cell area, and
      a side of the separator plate (e.g., planar metal sheet thereof), the fluid flow region for delivery of fluid to an outermost layer of electrochemically active cell area of an adjacent electrolyser cell unit
   or patterning an outermost layer of the electrochemically active cell area, the fluid flow region for delivery of fluid to the outermost layer of the electrochemically active cell area;
overlying the separator plate and the metal support plate such that the second side of the separator plate overlies and faces the first side of the metal support plate.

A method of operating an electrolyser cell unit is provided. The method comprises: providing a fuel to a first fluid flow region for delivery of fuel to a first side of (e.g., a cell layer comprising) an electrochemically active cell area (e.g., to a first side of the cell layer); exhausting a fluid from a second fluid flow region for exhaust of the fluid from a second side of the electrochemically active cell area (e.g., from a second side of the cell layer); and controlling the flow rate of fluid in the first fluid flow region at a flow rate at least twice the flow rate of fluid in the second fluid flow region. Preferably, the flow rate of fluid in the first fluid flow region is controlled at a flow rate at least three times, more preferably at least five times, still more preferably at least ten times, the flow rate of fluid in the second fluid flow region.

The method of operating an electrolyser cell unit may comprise providing a sweep gas to the second fluid flow region, wherein the controlling is further configured to control the flow rate of fuel provided to the first fluid flow region to be at least three times, optionally at least five times, optionally at least ten times, the flow rate of sweep gas provided to the second fluid flow region.

The controlling may be further configured to regulate a pressure difference between the first fluid flow region and the second fluid flow region to maintain a spaced arrangement between a cell layer and separator plate that forms the first fluid volume.

The pressure difference between the first fluid flow region and the second fluid flow region may be regulated to be in the range of 50 mbar to 2 bar, preferably between 100 mbar to 1.5 bar, more preferably 200 mbar to 800 mbar. The pressure difference is preferably regulated to decrease an electrical contact resistance between the separator plate and the electrochemically active cell area of a second, neighbouring, cell unit in a stack of cell units. By increasing the pressure difference, the electrical contact resistance may be decreased, thereby improving efficiency of the stack.

The pressure difference may be regulated by, for example, i) the use of pumps for the pumping of first fluid in the first fluid flow region and second fluid in the second fluid flow region at different rates ii) chokes such as valves, or convergent-divergent nozzles (such as a de Laval nozzles) in a pipe or flow path providing the fluids to a first fluid inlet to the first fluid flow region and a second fluid inlet or outlet to or from the second fluid flow region of the cell units and/or the cell stack as a whole, ili) orifice plates in the pipe or flow path to assist in the regulation of the pressure difference between the first fluid in the first fluid flow region and the second fluid in the second fluid flow region. Other ways and apparatus that may be used to establish a pressure difference between the first fluid flow region and the second fluid flow region will be readily known by the person skilled in the art.

### BRIEF DESCRIPTION OF THE DRAWINGS

FIG. 1 is an exploded perspective view of a fuel cell unit and two gaskets;

FIG. 2 is a second perspective view of the arrangement in FIG. 1, shown from a different angle;

FIG. 2a is a simplified cross-section of the arrangement of FIGS. 1 and 2;

FIG. 3 is a first exploded perspective view of a first arrangement comprising a stack of two cell units separated by gaskets, each cell with two fluid ports.

FIG. 4 is an underside exploded perspective view of the arrangement in FIG. 3;

FIG. 5 is a cross sectional view of the arrangement in FIG. 3;

FIG. 6 is a first exploded perspective view of a second arrangement comprising a stack of two cell units separated by gaskets, each cell with four fluid ports;

FIG. 7 is an underside exploded perspective view of the arrangement in FIG. 6;

FIG. 8 is a first exploded perspective view of a third arrangement comprising a stack of two cell units separated by gaskets, each cell with four fluid ports and a spacer plate.

FIG. 9 is an underside exploded perspective view of the arrangement in FIG. 8;

FIG. 10 is a cross sectional view of the arrangement in FIG. 8;

FIG. 11 illustrates a method of manufacturing a cell unit in accordance with the present invention.

FIG. 12 illustrates a method of operating a cell stack in a steady state in accordance with the present invention.

FIG. 13A is a schematic cross sectional view of an electrolyser cell unit.

FIG. 13B is an exploded perspective view of a fourth arrangement comprising a stack of two electrolyser cell units separated by gaskets, each electrolyser cell unit with four fluid ports.

FIG. 14 is an exploded perspective view of a fifth arrangement comprising a stack of two electrolyser cell units separated by gaskets, each electrolyser cell unit with four fluid ports.

FIG. 15 is an exploded perspective view of a sixth arrangement comprising a stack of two electrolyser cell units separated by gaskets, each electrolyser cell unit with two fluid ports.

FIG. 16 is an exploded perspective view of a seventh arrangement comprising a stack of two electrolyser cell units separated by gaskets, each electrolyser cell unit with four fluid ports.

FIG. 17 is an exploded perspective view of an eighth arrangement comprising a stack of two electrolyser cell units separated by gaskets, each electrolyser cell unit with four fluid ports.

FIG. 18 is an exploded perspective view of a ninth arrangement comprising a stack of two electrolyser cell units separated by gaskets, each electrolyser cell unit with four fluid ports and the electrolyser cell units each having a spacer plate.

FIGS. 19A and 19B are a first and second exploded perspective view of a tenth arrangement comprising a stack of two electrolyser cell units separated by gaskets, each electrolyser cell unit with four fluid ports.

FIG. 20 shows two cross-sections through the tenth arrangement of FIGS. 19A and 19B.

FIGS. 21A and 21B are a first and second exploded perspective view of an eleventh arrangement comprising a stack of two electrolyser cell units separated by gaskets, each electrolyser cell unit with four fluid ports.

FIG. 22 shows two cross-sections through the eleventh arrangement of FIGS. 21A and 21B.

FIGS. 23A-C is an exploded perspective view of a twelfth arrangement comprising a stack of two electrolyser cell units separated by gaskets, each electrolyser cell unit with four fluid ports;

FIGS. 24A-H shows simplified cross sections of electrolyser cell units of the invention;

FIGS. 25A-C is a plan view and associated cross-sectional views of a further arrangement of electrolyser cell units.

FIG. 26 illustrates a method of manufacturing an electrolyser cell unit in accordance with the present invention.

### DETAILED DESCRIPTION

For illustrative purposes only, the figures only indicate two electrochemical cell units (each hereafter referred to simply as a “cell unit”) in a stack. In various embodiments, multiple cells are provided. In further embodiments (not shown) multiple electrochemical cell stacks are provided, and in still further embodiments multiple electrochemical cell stacks each comprising multiple electrochemical cells are provided. It will be appreciated that the anode and cathode inlets, outlets (off-gas), ducting, and manifolding, and their configuration are modified as appropriate for such embodiments, and will be readily apparent to a person of ordinary skill in the art.

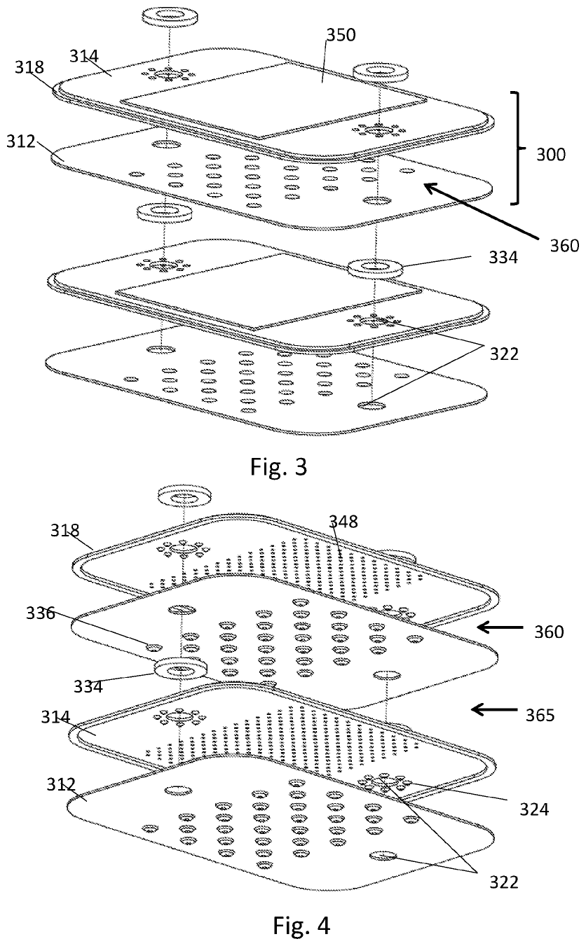

Referring to FIG. 3, cell unit 300 comprises a flat (i.e. planar) metal support plate 314 stacked next to a separator plate 312. The metal support plate 314 is shown to have flanged perimeter feature 318 around its perimeter. The flanged perimeter 318 extends out of the predominant plane of the sheet, as found at a central fluid volume area, to create a concavity in the metal support plate 314 (and a convexity to the outside surface). The concavity will form a first fluid volume 360 within this cell unit upon assembly of the cell unit. The separator plate has a first side and a second side, and comprises a metal sheet. The second side of the separator plate extends across and faces a first side of the cell layer. The two plates are sealed around their periphery (e.g. welded), to enclose/seal the enclosed first fluid volume.

The cell unit 300 has rounded ends and parallel sides, with one fluid port 322 towards each end in both the separator plate 312 and the metal support plate 314. Other shapes and sizes and numbers of the respective cell features are possible depending upon the required power and dimensions of the final stack assembly.

In a middle portion of the cell unit 300, an electrochemically active layer 350 is provided on a cell layer (here a metal support plate with a cell layer is shown). In this embodiment it is located outside of the first fluid volume 360.

The electrochemically active area 350 includes an anode, a cathode, and an electrolyte positioned between the anode and cathode (not shown). The anode, electrolyte, and cathode may together be referred to as the electrochemically active layer 350, active electrochemical cell layer, or electrochemically active region. The electrochemically active region may be a continuous and generally rectangular region, which may be generally uninterrupted. Alternatively, the electrochemically active cell region may be wrapped around the fluid ports to increase the proportion of the cell unit area that is electrochemically active and thereby increase a power density of the stack of cell units. In other words, in the vicinity of the ports, the edge of the active cell region is shaped to match the shape of the port.

The edge of the active cell region forms a part-circle which is concentric with the port. The edge of the active cell region is spaced from the edge of the port to allow space for formed port features and/or gaskets disposed around the port.

The electrolyte conducts either negative oxygen ions or positive hydrogen ions between the anode and cathode.

The stack may comprise a stack of cell units that are based on one of solid oxide electrolytes, polymer electrolyte membranes, or molten electrolytes or any other variant capable of electrochemistry.

FIG. 4 shows the same cell unit 300 as FIG. 3 but from a different perspective view. FIG. 5 shows a cross sectional view of FIG. 3. The section is taken from rear-left to front-right, to the rear of centre. Around the fluid ports of the metal support 314, shaped port features 324 are provided. The shaped port features 324 are provided as multiple elements in the form of protrusions extending out of the plane of the base of the fluid volume a distance corresponding to that of the height of the flanged perimeter 318—to have a common height therewith. This is so that they will contact the opposing surface of the separator plate 312, just like the flanged perimeter 318, when the cell unit 300 is assembled. As a result, when the flanged perimeter 318 are joined to the separator plate 312, for example by welding, the shaped port features 324 will likewise contact the separator plate 312. The protrusions may have a circular, square, cross, pentagonal, or hexagonal-shaped cross-section. They may also be oval or irregular polygon in cross-section.

The concave configuration can give the relevant plate the appearance of a rimmed tray, with a correspondingly convex outside shape (outside relative to the cell unit) and usually a planar base, the concavity thus defining (e.g. part of) the first fluid volume 360 in the assembled cell unit. In this concave configuration, the flanged perimeter 318 extends out of a plane of the original sheet of the separator plate, and/or of the metal support plate, toward a respective opposed surface of the other of the separator plate and the metal support plate.

The first fluid volume 360 is thus bordered by a flanged perimeter 318, which is formed by pressing, such as by use of a die press, hydroforming or stamping.

The metal support plate 314 (e.g. metal foil) is provided with multiple small holes or pores 348 to enable first fluid in the first fluid volume 360 to be in fluidic communication with the electrochemical layers supported by a second side (upper side as shown) of the cell layer/metal support plate. These holes or pores form a porous region bounded by a non-porous region. The anode (fuel electrode) layer is located adjacent the small holes/pores with the (enclosed) fluid volume 360 within the cell unit comprising a first fluid volume 360 supplied by first fluid entering and exiting via the fluid ports 322.

The first fluid may be fuel ((reformed) hydrocarbon or other fuel (e.g. ammonia) when operated as a fuel cell, and steam when operated as an electrolysis cell) in such case the fluid ports 322 are thus fuel ports 322. The anode (fuel electrode) layer may be coated or otherwise deposited on the metal support plate 314. The cathode (air electrode) layer is on the opposite side of electrochemically active layer 350, i.e. on its outer face, and is exposed to air flowing across that layer during use of the cell unit.

In the cell units depicted in FIGS. 3 & 4 & 5 only two layers (components) are required, i.e. the metal support plate and the separator plate.

The separator plate 312 is also provided with protrusions 336 which extend from the separator plate 312 towards an adjacent cell unit (in other words, away from the metal support plate 314 of the cell unit of which the separator plate is a constituent). Those downward protrusions 336 (within the plan view area of the electrochemically active layer) which include outward (down as shown) protrusions, extend from the separator plate 312 to contact, in a stack of cell units, an outer surface of the electrochemically active layer of a cell unit adjacent to the separator plate. The central downward protrusions 336 define fluid pathways between them or in them for oxidant (such as air) through a second fluid volume 365 defined between the outer surface of the electrochemically active layer of the cell unit adjacent to the downward protrusions.

When formed into a stack of cell units, a second side of the separator plate of a first cell unit faces a first side of a cell layer of a first cell unit, in a spaced arrangement to form the first fluid volume for the first fluid therebetween, and the first side of the separator plate of the first cell unit faces an electrochemically active cell area of a second, neighbouring, cell unit in the stack of cell units and defines a second fluid volume therebetween. The first fluid volume is for first fluid (such as fuel in the form of a reformed hydrocarbon fuel or other fuel (e.g. ammonia) in fuel cell operation, or for steam in electrolysis cell operation), and the second fluid volume is for second fluid (such as oxidant in fuel cell operation, or generated oxygen in electrolysis cell operation). Between each cell unit in the stack there is provided two or more gaskets 334 (one surrounding each port, of which there may be more than 2) underneath each cell unit i.e. gaskets are positioned between adjacent cell units in the stack. There may be plural inlet ports and plural outlet ports.

Each gasket 334 (also referred to as a “seal”) provides a primary sealing function and will preferably be compressible. The gaskets are subjected to compressive forces in the vicinity of the ports to achieve the sealing function. For example through means capable of applying a compressive force. The gaskets may be sized to cover all the shaped port features 324 of each fluid port 322 to prevent first fluid (such as fuel in the form of a (reformed) hydrocarbon fuel or other fuel (e.g. ammonia) in fuel cell operation or steam in electrolysis cell operation) that may be travelling through the fluid ports 322 from seeping between the outside of the cell unit 300 and the gasket 334, into the area external of the cell units, i.e. into the second fluid volume surrounding the cell units 300 (such as oxidant in fuel cell operation, or generated oxygen in electrolysis cell operation), or the fluid external of the fluid ports from seeping in the other direction—into the fluid ports. This can assist in preventing any mixing of the fluid inside the cell unit 300 and the fluid outside the cell unit 300, which may be fuel and oxidant—the polarity of the electrochemically active layers 350 determining which way round this will be.

The gaskets may also provide electrical insulation between a first cell unit and an adjacent fluid cell unit, so as to prevent a short circuit. The gaskets may be any suitable cell gaskets (sealing rings), such as, for example, Thermiculite (trade mark).

Compressive forces in the stack in the vicinity of the electrochemically active layer are typically required for good electrical contact between cell units in the stack and hence good conductivity through the stack. The central downward protrusions 336 create the required electrical contacts between cell units (and the adjoining, preferable fixing by welding, of separator and cell layer mean that those components are electrically connected). For example, when in a stack arrangement, the central downward protrusions 336 on the first side of the separator plate 312 of a first cell unit in the stack contacts an outermost layer of the electrochemically active cell area of an adjacent cell unit in the stack, providing electrical contact therebetween.

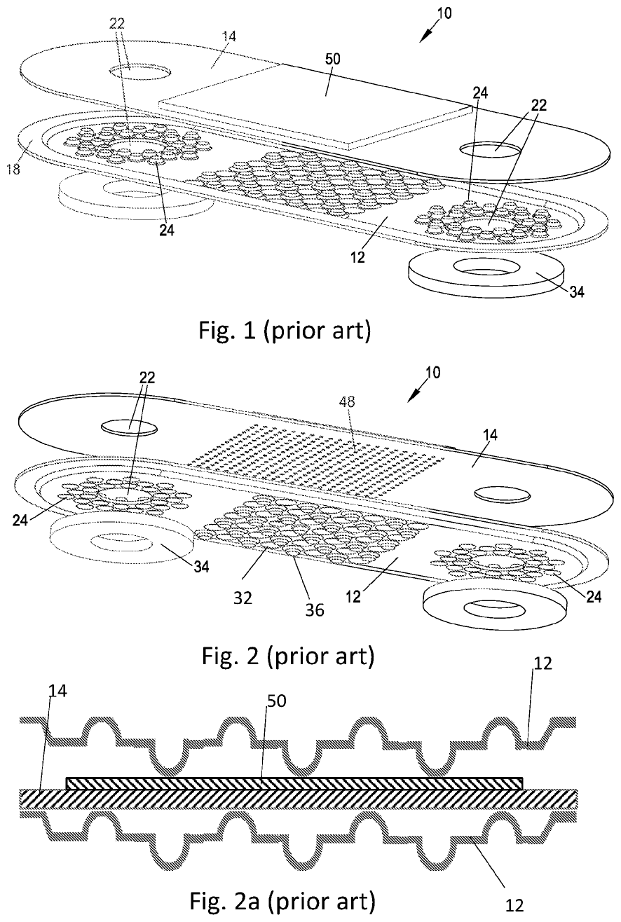

Unlike in the prior art shown in FIGS. 1 & 2, the first arrangement does not have central protrusions i.e. protrusions extending between the internal opposed surfaces of the two plates (i.e. the separator plate and the cell layer/metal support plate). Accordingly, the fuel is able to enter the first fluid volume 360 through the fluid ports 322, and flow freely across the whole surface of the separator plate 312 and through the whole first fluid volume.

Furthermore, as shown in FIGS. 3 & 4 & 5, the region of the separator plate 312 that underlies the electrochemically active layers 350 of the cell is clear of any other components that may act to separate the separator plate 312 from the metal support plate 314.

Also, unlike in the prior art shown in FIGS. 1 & 2, as the first arrangement does not have central upward protrusions extending between the internal opposed surfaces of the two plates, there is an absence of a feature in the cell unit that provides a support function for the cell unit in the central region, extending towards (or, as shown in FIGS. 3 & 4 & 5, upwardly to the underside of) the metal support plate at the area of the small holes (also referred to as the porous region, and corresponding to the plan view extent of the electrochemically active layers).

In previous designs (e.g. FIGS. 1 and 2), the cell units are stacked with the gaskets 34 between each repeat unit. Before compression, the gaskets 34 are thicker than the height of the protrusions 36 and the protrusions are not in contact with the next unit. As the stack is compressed, initially the compressive force acts solely through the gaskets (since the protrusions are not in contact). At a certain point, the gaskets 34 will be sufficiently compressed that the protrusions then come into contact. As the stack is further compressed, the compressive force acts through the gaskets 34 and the protrusions 36. This can lead to problems as described above.

With the new concept, since there are no protrusions directed toward the cell layer 348, the gaskets 334 can be compressed as required, without the compressive force also acting through protrusions or other structures in the vicinity of the active cell area (there may be some movement of the substrate/interconnect depending on stiffness, etc of the plates, but such movement is minor). Thus the compression in the active cell area is decoupled from the gasket compression, and can be controlled by the pressure difference—such pressure difference acting to push the cell layer (metal support plate 314 thereof) and interconnect 312 of that cell unit (of which said cell layer and interconnect are constituents) apart. In turn, the interconnect of that cell unit is urged towards and in contact with a neighbouring cell unit (typically the electrochemically active layer of the cell layer of a neighbouring cell unit) and thereby producing the required electrical contact between neighbouring cell units. With the new arrangement, the force conveyed by the protrusions 316 may be greatly reduced. The final force through the protrusions and the active area is achieved by the pressure difference.

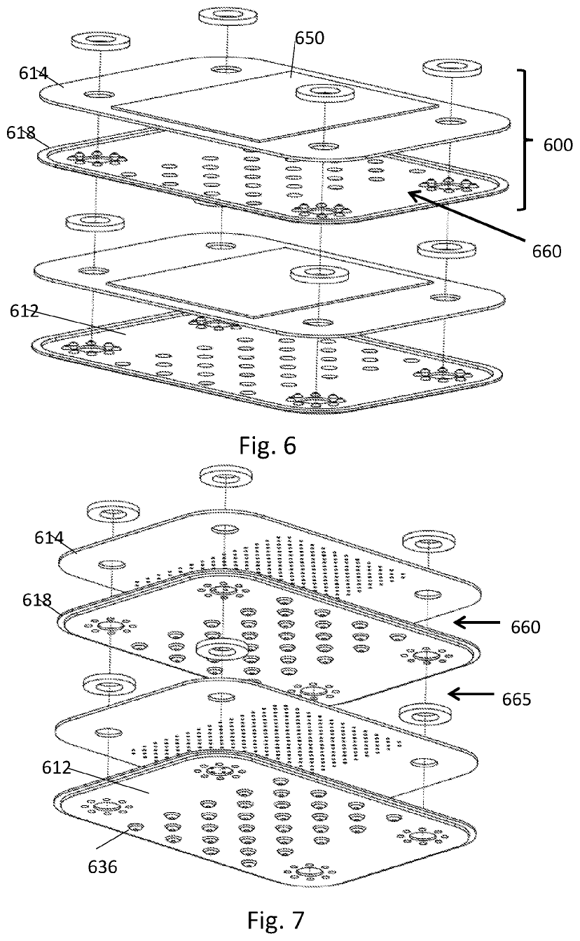

Referring to FIGS. 6 and 7, the cell unit 600 is similar to the cell unit 300 of FIGS. 3, 4 & 5 save that the separator plate 612 of the cell unit 600 is shown to have flanged perimeter 618 instead of the metal support plate 614, the shaped port features are provided in the separator plate 618, and a different arrangement of fluid ports is provided. The flanged perimeter 618 extends out of the predominant plane of the sheet, as found at a central fluid volume area, to create a concavity in the separator plate (and a convexity to the outside surface). The concavity will form a first fluid volume 660 within this cell unit upon assembly of the cell unit.

It should be noted that the arrangement of FIGS. 6 and 7 can be modified in ways already discussed in relation to the arrangement of FIGS. 3, 4 and 5. For example: the first fluid volume may be formed by a flanged perimeter in either or both of the separator and the metal support plate. Where both have flanges, the shaped port features may have a total height the same as the sum of both flanges. There may be a flange in one plate and port features in the other. There may be more than two ports.

The cell unit 600 has rounded ends and parallel sides, with one fluid port 622 towards each corner of both the separator plate 612 and the metal support plate 614, thereby giving a total of four fluid ports 622. Other shapes and sizes and numbers of the respective cell features are possible depending upon the required power and dimensions of the final stack assembly.

Around the fluid ports 622 of the separator plate 612, shaped port features are provided similar to the shaped port features of 324 of cell unit 300. The shaped port features are provided as multiple elements in the form of protrusions extending out of the plane of the base of the fluid volume 660 a distance corresponding to that of the height of the flanged perimeter 618—to have a common height therewith. This is so that they will contact the opposing surface of the metal support plate 614, just like the flanged perimeter 618, when the cell unit 600 is assembled. As a result, when the flanged perimeter 618 is joined to the metal support plate 614, for example by welding, the shaped port features will likewise contact the metal support plate 614. The protrusions may have a circular, square, cross, pentagonal, or hexagonal-shaped cross-section. They may also be oval or irregular polygon in cross-section.

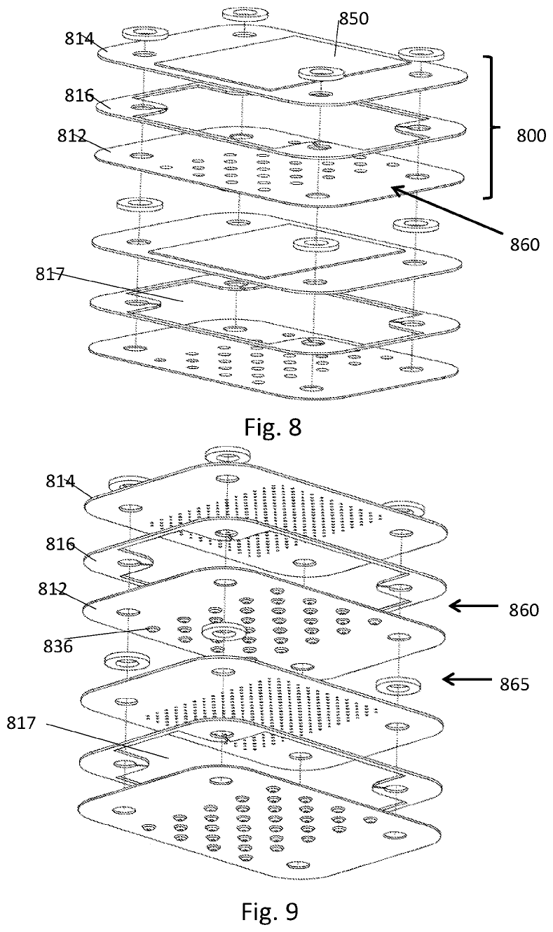

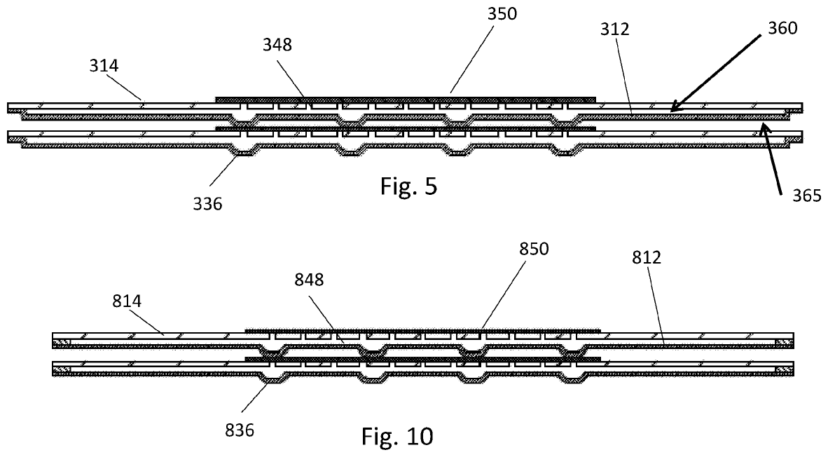

Referring to FIGS. 8, 9, and 10, the cell unit 800 is similar to the cell unit 300 & 600 described above (and is shown in similar views) save that neither the separator plate 812 nor the metal support plate 814 of the cell unit has a flanged perimeter. To create a first, enclosed, fluid volume 860 between the separator plate 812 and the metal support plate 814 of the cell unit 800, a spacer plate 816 is provided between the separator plate 812 and the metal support plate 814.

The cell unit 800 has rounded ends and parallel sides, with one fluid port 822 towards each corner of the separator plate 812, the metal support plate 814 and the spacer plate 816, thereby giving a total of four fluid ports 822. Other shapes and sizes and numbers of the respective cell features are possible depending upon the required power and dimensions of the final stack assembly.

The spacer plate 816, when in position in the cell unit overlies/underlies the perimeter of the separator plate 812 and underlies/overlies the perimeter of the metal support plate 814. A central hollow portion 817 of the spacer plate 816 at least overlies/underlies the central downward protrusions 836 extending between the separator plate 812 and the area of the electrochemically active layer of the cell unit adjacent to the outward protrusions. The hollow central portion 817 also at least underlies/overlies the porous region (multiple small holes) provided in the metal support plate 812 to enable fluid in the first fluid volume to be in fluidic communication with the side of the electrochemical layers that is closest to the metal support plate 814. The hollow portion 817 of the spacer plate 816, when sandwiched between the separator plate 812 and the metal support plate 814, forms a fluid volume between the separator plate 812 and the metal support plate 814 for fuel.

Unlike the first and second arrangements, the third arrangement does not have shaped port features around the fluid ports of the separator plate. The spacer plate acts to provide a separation between the metal support plate and the separator plate of the cell unit. Throats in the spacer plate allow fluidic communication between the ports and the first fluid volume.

In each arrangement described above, as there are no central upward protrusions extending between the internal opposed surfaces of the two plates (i.e. the separator plate and the cell layer/metal support plate), there is provided means of establishing and maintaining the first fluid volume 360; 660; 860 between the metal support plate 314; 614; 814 and the separator plate 312; 612; 812, during operation of the cell unit.

Where the cell unit 300; 600; 800 is a fuel cell unit (or a stack of fuel cell units), a fuel (i.e. the anode inlet gas e.g., a hydrocarbon fuel, reformed hydrocarbon fuel, H2, ammonia) is passed to the anode inlet of the cell unit and enters the first fluid volume (fuel volume) between the separator plate 312; 612; 812 and the cell layer (or metal support plate 314; 614; 814), via the ports 332; 632; 832. At the same time oxidant (i.e. the cathode inlet gas) is passed to the cathode inlet of the cell unit to flow either side of separator plate 312; 612; 812 and the cell layer (or metal support plate 314; 614; 814). The fuel and oxidant may flow in a co-flow configuration such that the fuel and the oxidant flow in the same direction across their respective sides of the cell unit. Alternatively, the fuel and oxidant may flow in counter or cross flow configuration.

Where the cell unit 300; 600; 800 is a fuel cell unit, the fuel and the oxidant are provided to the fuel cell unit at different pressures to provide a pressure difference between the fuel and the oxidant as they pass through the fuel cell unit. That in turn results in there being a pressure difference between a first side (proximate to the oxidant) and a second side of the separator plate 312; 612; 812 (proximate to the fuel). By providing a pressure difference between the first side and the second side, a separation between (the second side of) the separator plate and (the first side of) the cell layer (or the first side of the metal support plate 314; 614; 814) can be controlled. For example the separation can be maintained or increased to create and maintain the first fluid volume.

To enable the separation between the separator plate 312; 612; 812 and the cell layer (or metal support plate 314; 614; 814) to be maintained or increased through the provision of a pressure difference between the first side and the second side, the separator plate may be adapted, or configured, to flex when exposed to the pressure difference. For example, when exposed to the pressure difference the separator plate may flex away from the cell layer (or metal support plate) of the cell unit (and toward a neighboring cell unit) as the pressure difference is increased i.e. the separator plate is adapted to flex away from the cell layer (or metal support plate) when exposed to the pressure difference as a positive function of the pressure difference.

When in a stack arrangement, the central downward protrusions 336; 636; 836 on the first side of the separator plate 312; 612; 812 of a first cell unit in the stack contact an outermost layer of the electrochemically active cell area of an adjacent cell unit in the stack, providing electrical contact therebetween.

When each separator plate 312; 612; 812 is exposed to a pressure difference so as to cause it to flex away from the cell layer (or metal support plate 314; 614; 814) of its corresponding cell unit, a contact resistance between the central downward protrusions 336; 636; 836 and an outermost layer of the electrochemically active cell area of an adjacent cell unit decreases. In other words, the contact resistance between the central downward protrusions 336; 636; 836 and an outermost layer of the electrochemically active cell area of an adjacent cell unit decreases as the pressure difference between the first side and the second side of the separator plate increases.

During operation the pressure difference the first side and the second side of the separator plate can be controlled to be in the range of 50 mbar to 2 bar, preferably between 100 mbar to 1.5 bar, more preferably 200 mbar to 800 mbar.

A method of manufacturing any of the cell units described in any of the above embodiments includes a number of steps/operations. That method includes the following steps.

At step 1110, a separator plate having a first side and a second side is provided e.g. by cutting or stamping. The separator plate may, for example, be a planar metal sheet that is non-porous, or any other planar sheet that is non-porous, and which acts to separate one cell unit from an adjacent cell unit in a stack. The separator plate may be provided with protrusions extending out of a plate of the separator plate, which may be provided by pressing/forming in the same step as the cutting/stamping.

At step 1120, a cell layer is provided comprising an electrochemically active cell area which includes an anode, a cathode, and an electrolyte positioned between the anode and cathode (not shown). The cell layer has a first side and a second side, and may preferably be a metal supported cell layer. Adding the cell layer may include depositing or coating the cell layer on a planar metal sheet e.g. by printing the electrochemically active cell area on the cell layer, thus forming a metal supported cell layer, with a porous region (holes) providing fluidic communication from the first side to the electrode supported by the metal support plate on its second side. Alternatively, the cell layer may support itself. For example, the cell layer has an anode-supported, electrolyte-supported, or cathode-supported architecture. For the purposes of illustration only, the term ‘metal support plate’ is used in the following passages, but can be interchanged with ‘cell layer’ or ‘metal plate supported cell layer’.

Step 1110 or step 1120 preferably involves either providing a cell layer (or the metal plate supported cell layer) that has a flanged perimeter 318, or a separator plate that has a flanged perimeter 618. The flanged perimeter 318 or 618 extends out of the predominant plane of the metal plate support plate 314 or the separator plate 618 respectively.

The flanged perimeter 318 creates a concavity in the metal support plate 314 (and a convexity to the outside surface). The concavity forms a first fluid volume 360 within this cell unit upon assembly of the cell unit. The flanged perimeter 618 creates a concavity in the separator plate (and a convexity to the outside surface). The concavity forms a fluid volume within this cell unit upon assembly of the cell unit. The flanged perimeter in either the separator plate or the metal support plate may be made by pressing the separator plate or the metal support plate (of the cell layer) respectively.

Alternative to the flanged perimeter, a spacer plate may be provided and sandwiched between separator plate and metal support plate to form the first fluid volume therebetween.

Step 1110 and step 1120 also include providing a plurality of fluid ports 322; 622; 822 in both of the separator plate and the metal support plate to allow for the flow of a fluid (such as reformed fuel) through the cell units (and ultimately through a stack of cell units) to provide fuel to each cell unit, in particular to provide fuel to the first fluid volume of each cell unit.

At step 1130, the separator plate and the metal support plate are overlaid in a spaced arrangement to form a first fluid volume therebetween. Thus, the separator plate has a region that extends across at least the electrochemically active cell area. At step 1130, the separator plate and the metal support plate are overlaid so that the protrusions extending out of a plane of the separator plate are orientated to point away from the first fluid volume toward an adjacent cell unit when the cell unit is placed in a stack arrangement. In other words there is a continuous region that extends across at least the electrochemically active cell area that is clear of protrusions directed toward the metal support plate. It is also clear of any other component which is configured to resist a stack compression force and transfer such force to the protrusions which connect adjacent cell units. Thus there is no component within the first fluid volume, between the separator plate and metal support plate, to assist (in particular in operation) in the physical separation of them from one another.

At step 1130 the separator plate and metal support plate may be directly adjoined (and sealingly adjoined) at the flanged perimeter described above to form the first fluid volume therebetween. The separator plate and metal support plate may be directly adjoined optionally by welding.

In the alternative arrangement without the flanged perimeter, a spacer plate being provided and sandwiched between separator plate and metal support plate to form the first fluid volume therebetween, and at 1130 those three plates are sealingly fixed to one another, for example by welding around their periphery.

When forming a stack of cell units the method may continue, wherein the second side of the separator plate of a first cell unit (formed as described above) is arranged to overlie/underlie a second cell unit such that the first side of the separator plate of the first cell unit faces an electrochemically active cell area of a second, neighbouring, cell unit in the stack of cell units and encloses a second fluid volume therebetween. When forming the stack, a plurality of gaskets is provided, corresponding to the plurality of fluid ports of the cell units. Each gasket is positioned around the fluid ports of adjacent cell units in the stack. The function of the gaskets is already described above.

A method of operating a cell stack of cell units as described in the above embodiments includes a number of steps/operations, as follows.

At step 1210, a first fluid is provided to the first fluid volume formed between the separator plate and metal support plate. The first fluid may be a fuel. For operation as a fuel cell, the first fluid may be a hydrocarbon fuel, a reformed hydrocarbon fuel, ammonia, H2, methanol, etc. For operation as an electrolysis cell, the first fluid is typically steam.

At step 1220, a second fluid is provided to the second fluid volume formed between the separator plate of a first cell unit in the stack and an electrochemically active cell area of a second, neighbouring, cell unit in the stack. The second fluid may be an oxidant fluid. For operation as a fuel cell, the second fluid may be an oxidant fluid, for example, air or oxygen provided to the second fluid volume via an inlet. For operation as an electrolysis cell, the second fluid is typically oxygen produced in the electrolysis reaction.

At step 1230 a pressure difference between the first fluid volume and the second fluid volume is regulated to maintain the spaced arrangement that forms the first fluid volume. For example, a pressure of the first fluid (such as fuel) and the second fluid (such as air/oxygen) may be adjusted to produce a pressure difference between the two fluids. That pressure difference in turn may cause the separator plate to flex and a separation between the separator plate and the metal support plate may increase to form and maintain the spaced arrangement that forms the first fluid volume. The pressure difference between the first fluid volume and the second fluid volume may be in the range of 50 mbar to 2 bar, preferably between 100 mbar to 1.5 bar, more preferably 200 mbar to 800 mbar. Regulation of the pressure difference may also be to decrease an electrical contact resistance between the separator plate and the electrochemically active cell area of the second, neighbouring, cell unit in the stack (pressure in first fluid volume controlled to be greater than that in the second fluid volume, as that pressure difference is increased, contact resistance decreases).

The pressure difference may be regulated through the use of pressure pumps for the pumping of the first fluid and the second fluid at different rates. Alternatively, or additionally the flow of the first and/or second fluids may be chocked through the provision of a valve, or a convergent-divergent nozzle (such as a de Laval nozzle) in a pipe or flow path providing the fluids to the cell units of the stack. Alternative, or additionally, an orifice plate may be provided in a pipe or flow path to assist in the regulation of the pressure difference. Other ways and apparatus that may be used to establish a pressure difference will be readily known by the person skilled in the art.

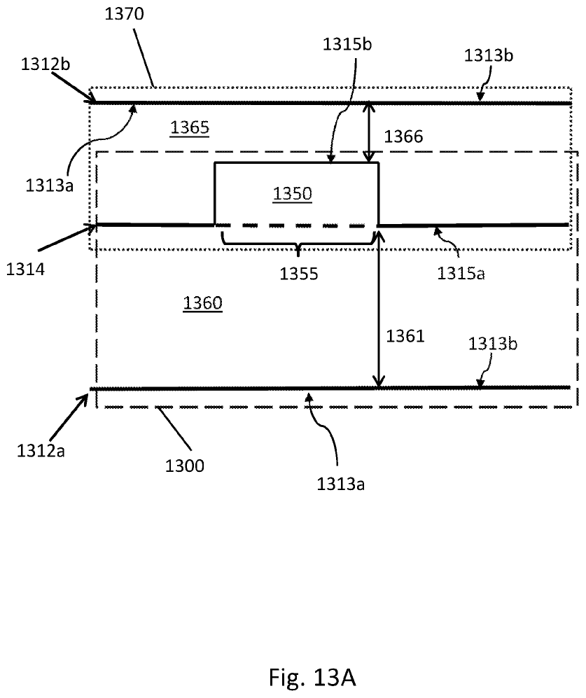

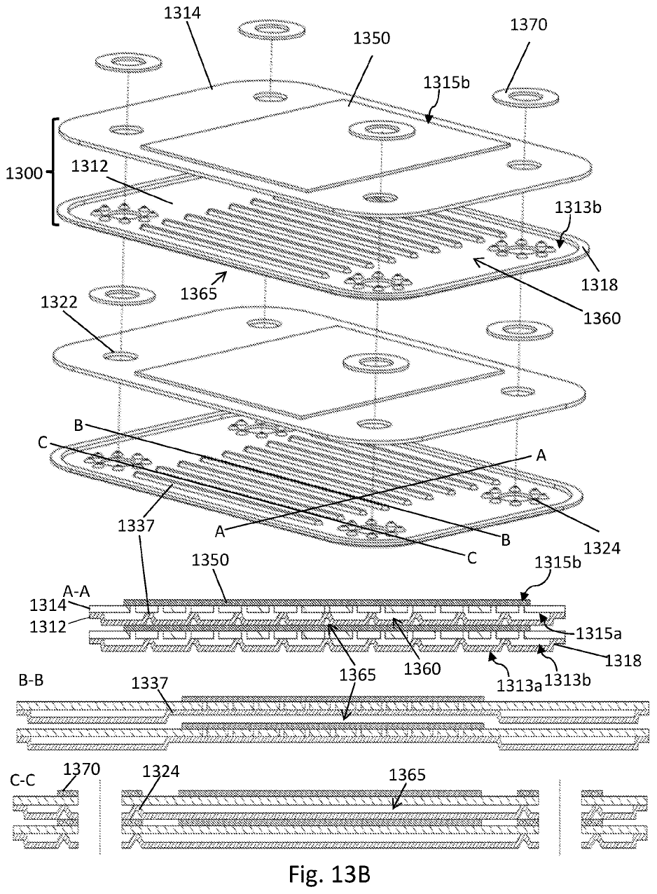

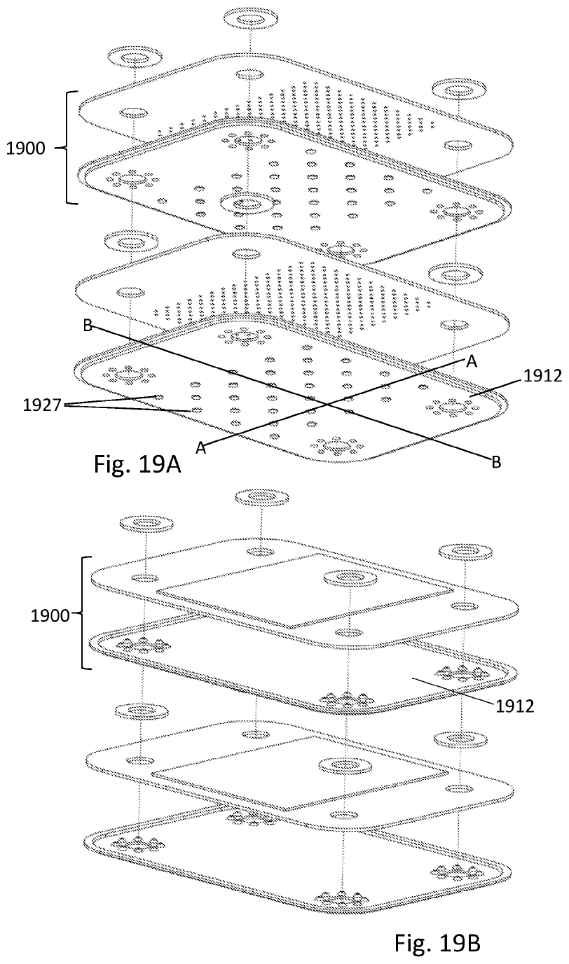

The cell units described with reference to FIGS. 3 to 10 may be fuel cell units or electrolyser cell units. Referring now to FIGS. 13 to 24 further electrolyser cell units will be described whose features may be combined with those described with reference to FIGS. 3 to 10, such as is described with reference to FIGS. 19 to 24. Referring to FIG. 13A, a simplified schematic of an electrolyser cell unit is shown. It will be appreciated that the electrolyser cell unit of FIG. 13A may be a special case of the cell units described with reference to FIGS. 3 to 10, and the nomenclature and arrangement of cell layer and separator plate into a cell unit (i.e. a repeat unit) is consistent with all examples described herein.

FIG. 13A depicts a cell layer 1314 and two adjacent separator plates 1312a and 1312b. It will be appreciated that these three components are merely exemplary, that a cell unit (i.e. a repeat unit) is constructed from one cell layer 1314 and one separator plate 1312, and that plural cell units may be stacked one upon the next to form a stack of cell units.

The cell layer includes an electrochemically active cell area 1350. That electrochemically active cell area 1350 may be self-supporting (in which case the cell layer may consist of the electrochemically active cell area 1350) or may be supported by a support plate (that support plate having a porous region for fluidic communication between the electrochemically active cell area 1350 and the first fluid flow region).

The cell layer 1314 and the separator plates 1312a, 1312b each have a first side and a second side. The first side 1313a of each separator plate 1312 faces the second side 1315b of each cell layer 1314. The second side 1313b of each separator plate 1312 faces the first side 1315a of each cell layer 1314.

A first fluid flow region 1360 is defined between the first side 1315a of the cell layer 1314 and the second side 1313b of the separator plate 1312. A second fluid flow region 1365 is defined between the second side 1315b of the cell layer 1314 and the first side 1313a of the separator plate 1312.

The first fluid flow region 1360 is for delivery of fuel to the first side of the cell layer 1314 (i.e. to a layer of the electrochemically active cell area 1350 which is in fluidic communication with the first fluid flow region 1360, optionally via the porous region 1355 of a support plate in cases where the cell layer 1314 comprises a support plate supporting the electrochemically active cell area 1350). The first fluid flow region 1360 also exhausts a product of an electrolysis reaction at the electrochemically active cell area 1350 (and exhausts any unused fuel).

The second fluid flow region 1365 is for exhaust of a product of the electrolysis reaction at the electrochemically active cell area 1350. In some cases, a sweep gas may also be supplied (and exhausted) via the second fluid flow region, that sweep gas to assist in exhausting of the off-gas. In the case where the off-gas is oxygen, build up of exhaust gas can be dangerous, especially when operating at elevated pressures and temperatures. The sweep gas may, for example, be oxygen, oxidant, air, or another suitable gas.

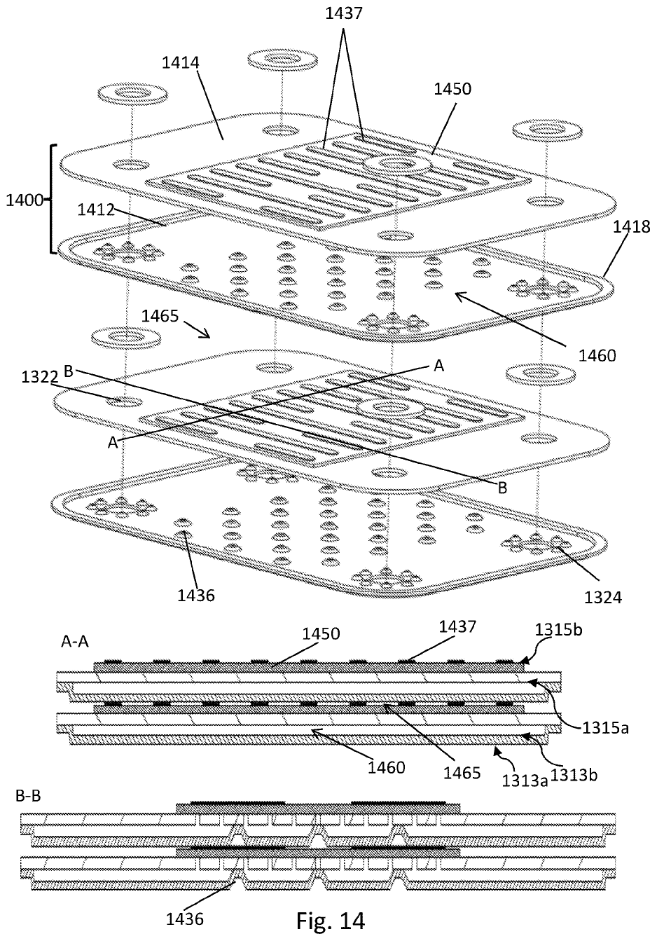

FIG. 13A depicts the cross-sectional area of the second fluid flow 1365 region as being smaller than the cross-sectional area of the first fluid flow region 1360. This cross-sectional area difference may be defined by the height h2 1366 of the second fluid flow 1365 region being smaller than the height h1 1361 of the first fluid flow region 1360. Alternatively, or additionally, the cross-sectional area may be defined by a plurality of channels, protrusions or other features (see FIGS. 14-24 and the associated description below). The ratio of cross-sectional areas (and in certain cases heights) may be 1:2 or lower, 1:3 or lower, or 1:10 or lower.

The intention of such an arrangement is to decrease contact resistance by increasing the contact area between the second side of the cell layer and the first side of the separator plate (i.e., which may be on the air side for an SOEC). This can be achieved by creating a separator plate having a ‘flat’ first side (which may be referred to as a ‘flat’ air side separator plate for an SOEC). In this context ‘flat’ means the separator plate itself (for example, a metal sheet forming the separator plate) has essentially no outwardly protruding features. It may have concave formations, and/or a series of discrete protrusions deposited on it to form the second fluid flow region (which may be referred to as a region for exhaust of fluid produced at the electrochemically active cell area, and, for an SOEC may be referred to as an air volume). In such a case, instead of just the peak of dimples (see FIGS. 1 and 2), a much larger contact area is available, thereby decreasing resistance in or between cell units and improving performance of electrolyser cell units and stacks thereof.

A separator plate 1312 (also referred to as an interconnect) having a ‘flat’ first side 1313a (‘air side’ for an SOEC) enables this increased contact area and this manifests by the cross-sectional area of the second fluid flow region (for second fluid, exhausted from the second side of the electrochemically active cell area, having been produced by the electrochemically active cell area, e.g., oxygen for SOEC) being lower than the cross-sectional area of the first fluid flow region (for first fluid, e.g., fuel, such as water for SOEC).

The volume flow rate in the second fluid flow region (‘air side’) can be significantly lower than that of the first fluid flow region (‘fuel side’) for electrolysers, in part as cooling properties of an air flow are not required for the endothermic electrolysis reaction unlike for operation as a fuel cell; so a corresponding reduction in the cross-sectional area is possible. However, as is discussed below, reducing this too far risks creating an unacceptably high pressure difference between the air and fuel side which can damage the cell.

As will be discussed below, in some examples, this can also mean the separator plate requires less forming/pressing. Such an interconnect can be made more robust and/or reliable (e.g. fewer defects are introduced during manufacture). This can result in a cost saving in the manufacturing process (even considering the cost of increased amounts of ceramic material if such material is used in providing the fluid flow region).

The area specific resistance has been noted to have decreased by up by 10% in some arrangements where a ‘flat’ air side separator plate has been used, and hence the power density increasing by the same amount.

In a particularly advantageous embodiment, both sides 1313a, 1313b of the separator plate are ‘flat’ where layers of discrete protrusions on the separator plate and/or electrochemically active area 1315b form the respective fluid flow regions. Such embodiments are shown in FIGS. 19-23 and 24F.

An electrolyser cell unit (i.e. a repeat unit, plural units forming a stack) comprises one cell layer 1314 and one separator plate 1312. In an example, electrolyser cell units 1300 are formed from the cell layer 1314 and the separator plate 1312a, such that said components enclose the first fluid flow region 1360 between the second side 1313b of the separator plate and the first side of the cell layer 1315a, when so enclosed the first fluid flow region may be referred to as the first fluid volume. When two electrolyser cell units 1300 are stacked, the second fluid flow volume 1365 is bounded between the second side 1315b of the cell layer 1314 of a first cell unit 1300 and the first side 1313a of the separator plate 1312b of a second, neighbouring (also referred to as adjacent), cell unit 1300 and may be referred to as the second fluid volume.

In an example, electrolyser cell units 1370 are formed from the cell layer 1314 and the separator plate 1312b, such that said components enclose the second fluid flow region 1365 between the first side 1313a of the separator plate and the second side 1315b of the cell layer, when so enclosed the second fluid flow region may be referred to as the second fluid volume. When two electrolyser cell units 1370 are stacked, the first fluid flow volume 1360 is bounded between the first side 1315a of the cell layer 1314 of a first cell unit 1300 and the second side 1313b of the separator plate 1312a of a second, neighbouring (also referred to as adjacent), cell unit 1370 and may be referred to as the first fluid volume.

The cell layer is typically planar, at least within the plan view area of the electrochemically active cell area 1350. The separator plate is typically formed from a planar sheet, for example a metal sheet. In the electrolyser cell units of FIGS. 13 to 22, the separator plate does not have any protrusions out of the first side 1313a thereof, at least within the plan view area of the electrochemically active cell area 1350. In other words, the separator plate (specifically, the (e.g., metal) sheet forming the separator plate) does not have any formed or pressed dimples which protrude into the second fluid flow region 1365, unlike in FIGS. 1 and 2. Instead, features are provided in or on second side 1315b of the cell layer 1314 and/or on the first side 1313a of the separator plate 1312 to form the second fluid flow regions 1365. Those features may be ribs or discrete protrusions provided in or on the second side 1315b of the cell layer 1314 and/or on the first side 1313a of the separator plate 1312 to form points of contact between the first side 1313a of separator plates 1312 and second side 1315b of cell layers 1314 to provide electrical contact (and/or to transfer compression force) through or between cell units, said ribs or discrete protrusions are described with reference to FIGS. 13B to 24. Alternatively, the features may be a porous layer between the second side 1315b of the cell layer 1314 and the first side 1313a of the separator plate 1312. That porous layer may be deposited or coated on either or both of the second side 1315b of the cell layer 1314 and the first side 1313a of the separator plate 1312, or may be a component therebetween (e.g., an expanded metal sheet or mesh).

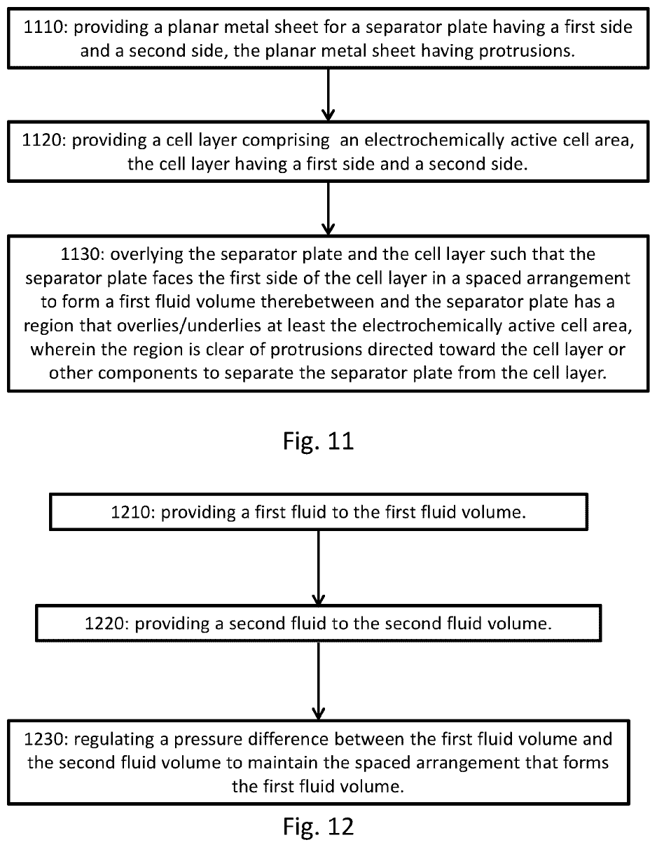

Similar features in the form of a porous layer, ribs, or discrete protrusions on the second side 1313b of the separator plate 1312, or on or in the first side 1315a of the cell layer 1314, may be provided to form points of contact between the second side 1313b of the separator plate 1312 or on or in the first side 1315a of the cell layer 1314, to provide electrical contact and/or to transfer compression force through or between cell units. Alternatively, formed or pressed dimples (not shown) may protrude from the second side 1313b of the separator plates 1312 towards and in contact with the first side 1315a of the cell layers 1314, said dimples being part of the metal sheet forming the basis for the separator plate. Alternatively, or additionally, the separator plate may be configured to be exposed to a pressure difference between the first fluid flow region and the second fluid flow region, as described with reference to FIGS. 3 to 12, 19 and 20. Said pressure difference obviates the dimpled protrusions in the first fluid flow region. The ribs or discrete protrusions, or the dimples, or the pressure difference are used to maintain the height 1361 of said first fluid flow region 1360, as further described with reference to FIGS. 13B to 24.

Referring to FIG. 13B, two example electrolyser cell units 1300 are shown in an exploded perspective view alongside cross-sections A-A, B-B, and C-C through two electrolyser cell units in a stacked arrangement (note that the height direction in the cross-sections is exaggerated for clarity). Electrolyser cell unit 1300 comprises a cell layer comprising an electrochemically active cell area 1350, the electrochemically active cell area 1350 having a first side and a second side. A first fluid flow region 1360 is provided to the first side of the electrochemically active cell area 1350. A second fluid flow region 1365 is provided to the second side of the electrochemically active cell area 1350. In an example electrolyser cell unit, the first fluid flow region is for delivery of fuel to the first side of the electrochemically active cell area 1350, the second fluid flow region is at least for exhaust of a fluid from the second side of the electrochemically active cell area 1350, and a cross-sectional area of the second fluid flow region is smaller than a cross-sectional area of the first fluid flow region. The smaller cross-sectional area (by reduced height thereof) of the second fluid flow region enables an increased number of cell units in a given height (or, phrased differently, a reduced total stack height for a given number of cell units) thereby increasing the power density of the cell units (and stacks thereof).

In FIG. 13B, the cell layer comprises flat (i.e. planar) metal support plate 1314 carrying the electrochemically active cell area 1350, and that cell layer is stacked next to a separator plate 1312 to form the electrolyser cell unit 1300. In this example cell unit 1300 is formed from a separator plate whose second side 1313b faces a first side 1315a of the cell layer (and therefore first side of the electrochemically active cell area 1350). Conversely, the cell unit could be referred to as one in which a first side 1313a of the separator plate faces the second side 1315a of the cell layer (and therefore second side of the electrochemically active cell area 1350).

The cell unit 1300 has rounded ends and parallel sides, with four fluid ports 1322 towards each corner in both the separator plate 1312 and the metal support plate 1314. Other shapes and sizes and numbers of the respective cell features are possible depending upon the required power and dimensions of the final stack assembly.

The separator plate 1312 is shown to have a flange 1318 around its perimeter. The flange 1318 extends out of the predominant plane of the sheet, as found at a central fluid volume area, to create a concavity in the separator plate 1312 (and a convexity to the outside surface). The concavity forms a first fluid volume 1360 within the cell unit upon assembly of the cell unit. The first fluid volume 1360 provides a first fluid flow region for delivery and/or exhaust of first fluid, which is provided and removed therefrom by ports in the separator plate and metal support plate. The separator plate has a first side and a second side, and comprises a metal sheet. The second side of the separator plate extends across and faces a first side of the cell layer. The two plates are sealed around their periphery (e.g. welded), to enclose and seal the enclosed first fluid volume. The flange 1318 is shown to be in the separator plate, however it will be understood in this and subsequent examples that the flange may alternatively be in the metal support plate, or the total height of the first fluid volume may be provided by corresponding flanges provided in the metal support plate and separator plate which face one another.

The concave configuration can give the relevant plate the appearance of a rimmed tray, with a correspondingly convex outside shape (outside relative to the enclosed volume of the cell unit) and usually a planar base, the concavity thus defining (e.g. part of) the first fluid volume 1360 in the assembled cell unit. In this concave configuration, the flange 1318 extends out of a plane of the separator plate, and/or of the metal support plate, toward a respective opposed surface of the other of the separator plate and the metal support plate.

The first fluid volume 1360 is thus bordered by a flange 1318, which may be formed by pressing, such as by use of a die press, hydroforming or stamping.

In a middle portion of the cell unit 1300, the cell layer has an electrochemically active cell area 1350 supported by the metal support plate 1314. In this example, the electrochemically active cell area 1350 is supported by the metal support plate on an opposite side of the metal support plate to that which faces the first fluid volume 1360, and a porous region of the metal support plate allows fluidic communication between the first fluid volume 1360 and one electrode of the electrochemically active cell are 1350. Use of the metal support plate enables the electrochemically active cell area 1350 to be coated or deposited thereon. However, it will be appreciated that the cell layer may be formed by electrochemically active cell area which is self-supporting.

The electrochemically active area 1350 includes an anode, a cathode, and an electrolyte positioned between the anode and cathode (individual layers not shown). The anode, electrolyte, and cathode may together be referred to as the electrochemically active area 1350, active electrochemical cell layer, or electrochemically active region. The electrochemically active area may be a continuous and generally rectangular region. Additionally, the electrochemically active cell area may be wrapped around the fluid ports to increase the proportion of the cell unit area that is electrochemically active and thereby increase a current density of the stack of cell units. In other words, in the vicinity of the ports, the edge of the active cell region may be shaped to match the shape of the port. For example, the edge of the electrochemically active cell area may form a part-circle which is concentric with the port. In such cases, the edge of the electrochemically active cell area is spaced from the edge of the port to allow space for formed port features and/or gaskets 1370 disposed around the port.

The electrolyte conducts either negative oxygen ions or positive hydrogen ions between the cathode and anode depending on the specific type of electrochemically active cell area. For example, a solid oxide electrolyser cell (SOEC) will conduct oxygen ions from the fuel side of the electrochemically active cell area to the other side of the electrochemically active cell area thereby producing oxygen at that other side for exhaust by the second flow region. In contrast, a proton-exchange membrane (PEM) electrolyser cell will conduct hydrogen ions from the fuel side of the electrochemically active cell area to the other side of the electrochemically active cell area thereby producing hydrogen at that other side for exhaust by the second flow region. Other types of electrochemically active cell areas, such as molten electrolytes exist and may be used.

The metal support plate 1314 (e.g. metal foil) is provided with a porous region, typically formed by multiple small holes or pores (shown in cross section A-A) to enable first fluid in the first fluid volume 1360 to be in fluidic communication with the first side of the electrochemically active cell area 1350 supported by a second side (upper side as shown) of the metal support plate. This porous region is bounded by a non-porous region, and the electrochemically active cell area covers the entirety of the porous region. The cathode (fuel electrode) layer is located adjacent the small holes/pores with the (enclosed) fluid volume 1360 within the cell unit comprising a first fluid volume 1360 supplied and exhausted by first fluid entering and exiting via the fluid ports 1322.

The first fluid may be a fuel for the electrolyser cell. The fuel for the electrolyser cell may be H₂O (typically in the form of steam). In the case where the electrochemically active cell area 1350 conducts oxygen ions (e.g., a solid oxide electrochemically active cell region), the cathode (fuel electrode) layer may be coated or otherwise deposited on the metal support plate 1314. The anode (air electrode) layer is on the opposite side of electrochemically active cell area 1350, i.e. on its outer face. In use, the electrochemically active cell area 1350 conducts oxygen ions, and so oxygen is produced at the second (anode) side of the electrochemically active cell area 1350 for exhaust by the second fluid flow region and hydrogen is produced at the first (cathode) side—i.e. fuel side—of the electrochemically active cell area 1350 for exhaust by the first fluid flow region. It will be appreciated that if the electrochemically active cell area 1350 conducts hydrogen ions, then hydrogen is produced in at the second side of the electrochemically active cell area 1350 for exhaust by the second fluid flow region and oxygen is produced at the first side—i.e. fuel side—of the electrochemically active cell area 1350 for exhaust by the first fluid flow region. It will be appreciated that fuels other than steam may be used, with corresponding ions being conducted by the electrochemically active cell area 1350. For example, carbon dioxide may be used in a SOEC as a fuel, that fuel being reduced by the electrochemically active cell area 1350. A sweep gas may be provided to the second fluid flow region to assist with extraction of product of the electrolysis reaction at the second side of the electrochemically active cell area.

Around the fluid ports of the separator plate 1312, shaped port features 1324 are provided. The shaped port features 1324 are provided as multiple elements in the form of protrusions extending out of the plane of the base of the fluid volume a distance corresponding to that of the height of the flange 1318—to have a common height therewith. This is so that they will contact the opposing surface of the metal support plate 1312, just like the flange 1318, when the cell unit 1300 is assembled. The flange and/or port features may be provided in one or both of the metal support plate and separator plate.

As a result, when the flange 1318 is joined to the metal support plate 1314, for example by welding, the shaped port features 1324 will likewise contact the metal support plate 1314. The protrusions may have a circular, square, cross, pentagonal, or hexagonal-shaped cross-section. They may also be oval or irregular polygon in cross-section. The protrusions are configured to transfer a force of compression through the stack, that compression used to compress the gaskets 1370 between cell units and seal said gaskets 1370 against contacting surfaces (the second side 1315b of the cell layer 1314 and the first side 1313a of the separator plate 1312).

The separator plate 1312 is also provided with features pressed therein. Said features are ribs 1337 which protrude from the second side 1313b of the separator plate (towards the cell layer of that cell unit) and which form corresponding depressions in the first side 1313b of the separator plate. The protruding part of the ribs 1337, which protrude into the first fluid flow region, contact the cell layer of that cell unit to provide mechanical support and electrical contact through the cell unit. The depression part of the ribs 1337 provides a second fluid flow region. The first side 1313a of the separator plate 1312 (specifically, the planar part thereof) contacts the outermost layer of an adjacent electrochemically active cell area 1350 (e.g., in FIG. 13B, the first side 1313a of the separator plate 1312 of cell unit 1300 contacts the electrochemically active cell area 1350 of the adjacent cell unit). The ribs 1337 extend across a length of the second side 1313b of the separator plate 1312 so as to extend beyond the edges of the electrochemically active cell area 1350 when the separator plate and the metal plate are adjacent to one another. The ribs 1337 protrude from the separator plate 1312 towards the metal support plate 1314 of the cell unit, thereby forming wide channels on the second side of the separator plate 1312. The opposite side of those ribs 1337 provides concave channels on the first side of the separator plate that define the second fluid flow region in a second fluid volume 1365. That the second fluid flow region in a second fluid volume 1365 is defined between the outer surface of the electrochemically active cell area 1350 of the adjacent cell unit and the (concave or depressed side of the) ribs 1337. Since the ribs are longer than the length of the electrochemically active cell area 1350, and therefore extend beyond the edges of the electrochemically active cell area 1350, they are able to deliver and/or exhaust second fluid from the outermost layer of the electrochemically active cell area 1350 of the adjacent cell unit.

The number and cross-sectional area of the ribs is such that the cross-sectional area of the first fluid flow region is larger than that of the second fluid flow region. A ratio between the cross-sectional area of the second flow region and the cross-sectional area of the first flow region is 1:3 or lower, optionally 1:10 or lower.

When formed into a stack of cell units, a second side of the separator plate 1312 of a first cell unit faces a first side of a cell layer of a first cell unit, in a spaced arrangement to form the first fluid volume 1360 for the first fluid therebetween, and the first side of the separator plate of the first cell unit faces second side of a cell layer of a second, neighbouring, (i.e. adjacent) cell unit in the stack of cell units and defines a second fluid volume 1365 therebetween. The first fluid volume is for first fluid (typically fuel, such as steam in electrolysis cell operation), and the second fluid volume is for second fluid (such as generated oxygen in electrolysis cell operation). Between neighbouring (i.e. adjacent) cell units in the stack there is provided gaskets 1370. One gasket typically surrounds each port, of which there is typically 2 or more—at least one inlet port to and one outlet port from the first fluid volume. There may be plural inlet ports and plural outlet ports, each with corresponding gaskets.

When formed into a stack of cell units the stack is configured such that a cross-sectional area of the first fluid flow region (which may be at least a portion of the first fluid volume within the plan view area of the electrochemically active cell area 1350) is greater than the cross-sectional area of the second fluid flow region (which may be at least a portion of the second fluid volume within the plan view area of the electrochemically active cell area 1350). In other words the fluid volume for the fuel (e.g., steam) has a greater cross-sectional area than the second fluid volume for product of the electrolysis reaction (e.g., oxygen for an electrochemically active cell area 1350 which conducts oxygen ions).

Each gasket 1370 (also referred to as a “seal”) provides a primary sealing function and will preferably be compressible. The gaskets are subjected to compressive forces in the vicinity of the ports to achieve the sealing function. For example, through means capable of applying a compressive force. The gaskets may be sized to surround each fluid port 1322 to prevent first fluid (such as steam in electrolysis cell operation) that may be travelling through the fluid ports 1322 from seeping between the outside of the cell unit 1300 and the gasket 1370, into the area external of the cell units, i.e. into the second fluid volume surrounding the cell units 1300 (such as generated oxygen for an SOEC), or the fluid external of the fluid ports from seeping in the other direction-into the fluid ports. This prevents any mixing of the fluid inside the cell unit 1300 and the fluid outside the cell unit 1300. The port features 1324 of the separator plate contact the cell layer of the same cell unit in order to transfer the compressive force through the cell unit, to act on gaskets throughout the stack.

The gaskets may also provide electrical insulation between a first cell unit and an adjacent fluid cell unit, so as to prevent a short circuit. The gaskets may be any suitable cell gaskets (sealing rings), such as, for example, Thermiculite (trade mark).

The compressive forces through the stack also act to ensure good electrical and mechanical contact of separator plates with cell layers (the metal support plate and/or electrochemically active cell area 1350). Typically, fuel is provided to the first fluid volume 1360 at two of the ports 1322 (e.g. the two ports to the right-hand side of the figure) and flows along the length of the cell unit through the first fluid flow region, across the electrochemically active cell area 1350 (thereby supplying fuel to the same) and the product of the electrolysis reaction (and any unused fuel/any non-usable components thereof) is exhausted from the first fluid volume 1360 by the other two ports 1322 (at the opposite end of the cell unit, to the left hand side of the figure). In this case, product of the electrolysis reaction is exhausted by the second fluid flow region, that product flowing in a parallel or anti-parallel direction relative to first fluid flow region.

Referring to FIG. 14, two example electrolyser cell units 1400 are shown in an exploded perspective view alongside cross-sections A-A and B-B through two electrolyser cell units in a stacked arrangement (note that the height direction in the cross-sections is exaggerated for clarity). The electrolyser cell unit 1400 is similar to the cell unit 1300 of FIG. 13B save that a side of the electrochemically active cell area 1450 adjacent to the second fluid volume 1465 in the assembled cell unit is provided with a pattern of linear protrusions 1437. Those linear protrusions 1437 have a peak that has a height above the outermost layer of the electrochemically active cell area 1450. This creates the second fluid flow region (i.e. between the sides of the protrusions 1437, the outermost layer of the electrochemically active cell area 1450, and the first side of the separator plate 1412 of a neighbouring cell unit). This second fluid flow region is part of the second fluid volume 1465 for exhaust and/or delivery of second fluid to the electrochemically active cell area 1450 (typically exhaust of product of the electrolysis reaction). The linear protrusions 1437 are provided instead of the ribs 1337 of FIG. 13B and fulfil a similar function to the second side of the ribs 1337 (the concave side), as described above.

The linear protrusions 1437 may be of a different material to that of the outermost layer of the electrochemically active cell area 1450, manufactured by depositing material onto the outermost layer of the electrochemically active cell area 1450 (e.g., by screen printing, ink jet printing etc.). Alternatively, the linear protrusions may be of the same material as that of the outermost layer of the electrochemically active cell area 1450. This may be achieved by depositing additional material to create the protrusions, or by removal of material from the outermost layer of the electrochemically active cell area 1450. Such removal may be by etching or machining, for example.

The liner protrusions 1437 are shown as being parallel to the length of the cell unit (and parallel to the general direction of flow in the first fluid flow region). As such, the second fluid flow region is parallel and/or anti-parallel to the first fluid flow region, resulting in a co-flow or counter-flow arrangement for the cell units. However, that need not be the case. The liner protrusions 1437 (and therefore flow in the second fluid flow region) may have any orientation with respect to the first fluid flow region. A preferred example is for the liner protrusions 1437 to be perpendicular to the first fluid flow region, resulting in a cross-flow arrangement for the cell units.

Additionally, the separator plate 1412 is provided with a plurality of dimpled protrusions 1436 on the second side of the separator plate 1412, which extend from the separator plate 1412 towards the metal support plate 1414 of the cell unit of which the separator plate is a constituent. These are provided instead of ribs 1337 of FIG. 13B and perform a similar function to the first side of the ribs 1337 (the protruding side). The dimpled protrusions 1436 extend from the second side of the separator plate 1412 to contact the first side of the cell layer (in the case of FIG. 14, a first side of the metal support plate 1414, opposite to the side of the metal support plate supporting the electrochemically active cell area 1450).

The dimpled protrusions may have a circular, square, cross, pentagonal, or hexagonal-shaped cross-section. They may also be oval or irregular polygon in cross-section. They may have a length that is not more than 3 times their width. For this reason, they may also be referred to as dimples. The dimpled protrusions 1436 do not restrict flow of fluid within the first fluid flow region/first fluid volume 1460. The dimpled protrusions 1436 are formed by pressing (e.g., stamping or hydroforming) the metal sheet forming the separator plate 1412 such that they form a convex protrusion on the second side 1313b and a concave depression on the first side 1313a of the separator plate.

Around the fluid ports 1322 of the separator plate 1412, shaped port features are provided similar to the shaped port features 1324 of cell unit 1300. The shaped port features 1324 and dimpled protrusions 1436 are provided as multiple elements in the form of protrusions extending out of the plane of the separator plate 1412 a distance corresponding to that of the height of the flange 1418—to have a common height therewith. This is so that each of the flange 1418, shaped port features 1324 and dimpled protrusions 1436 contact the opposing surface of the cell layer (in this case, the metal support plate 1414) when the cell unit 1400 is assembled.

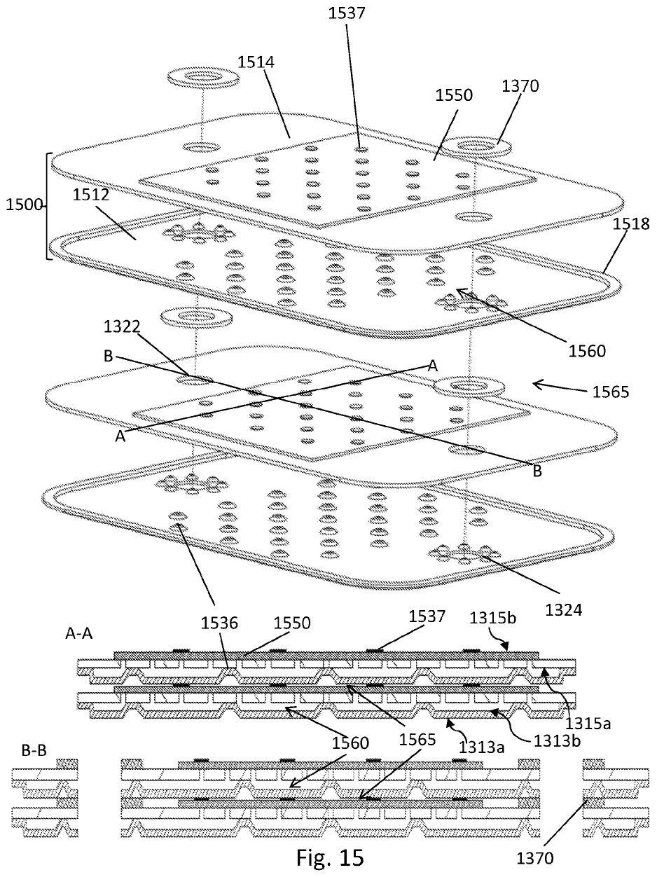

Referring to FIG. 15, two example electrolyser cell units 1500 are shown in an exploded perspective view alongside cross-sections A-A and B-B through two electrolyser cell units in a stacked arrangement (note that the height direction in the cross-sections is exaggerated for clarity). The electrolyser cell unit 1500 is similar to the cell unit 1400 of FIG. 14 save that instead of linear protrusions 1437 to create the second fluid flow region and second fluid volume there is provided discrete protrusions (or dimples) 1537 that extend upwards from a surface of the electrochemically active area 1550. The discrete protrusions 1537, in combination with the electrochemically active cell area 1550 and the first side 1313a of an adjacent separator plate, create the second fluid flow region 1365 in the same way as described with reference to the linear protrusions 1437 of FIG. 14. The discrete protrusions 1537 do not restrict the direction of flow of fluid in the second fluid flow region.

The discrete protrusions 1537 are shown to have a circular cross section (which is largely consistent in their height direction). This need not be the case. They may taper in height or length/width, and may have cross-sections other than circular, for example they may have a circular, square, cross, pentagonal, or hexagonal-shaped cross-section. They may also be oval or irregular polygon in cross-section. They may have a length that is not more than 3 times their width. In any case, the discrete protrusions 1537 do not restrict flow of fluid within the fluid flow region.

The discrete protrusions 1537 may be of similar materials and manufactured in similar ways (e.g., deposited or printed as discrete protrusions, or etched/machined from a layer) as described with reference to the linear protrusions 1437.

The height of the discrete protrusions is lower than that of the height of the first fluid volume. It is advantageous to have a small second fluid volume for the electrical conductivity and current density reasons discussed above, but too small can generate a large pressure differential between fuel and air sides which can lead to inefficient operation and/or damage to the stack.

In an example where the first fluid volume is 0.45 mm, it has been found that while discrete protrusions of 0.05 mm generate a relatively large pressure drop on the in the second fluid flow region, such a low height may be acceptable in some instances.

A height of around 0.2 mm has been found to be a good compromise.

Thus, the ratio of heights of the first fluid volume to the second fluid volume is greater than 1:1, preferably from between 10:1 and 1:1, more preferably between 10:1 and 2:1, more preferably between 4:1 and 2:1.

In the example where the first volume has a height of 0.45 mm, example ranges are 0.01-0.45 mm, preferably 0.05-0.25 mm, more preferably 0.1-0.2, or 0.1-0.15 mm, or 0.15-0.2 mm.

The same heights apply to the pressed ribs of FIG. 13B and the linear protrusions of FIG. 14.

In addition, in the example cell unit 1500 only two fluid ports 1322 are provided. One fluid port as an inlet to and the second fluid port as an outlet from the first fluid volume (for supply and exhaust from the first fluid flow region). Around the fluid ports 1322 of the separator plate 1512, shaped port features are provided similar to the shaped port features of 1324 of cell unit 1300. The shaped port features are provided as multiple elements in the form of protrusions extending out of the plane of the separator plate 1512 a distance corresponding to that of the height of the flange 1518 and dimples 1536 (which are substantially similar to the dimples 1436 of FIG. 14)—to have a common height therewith.

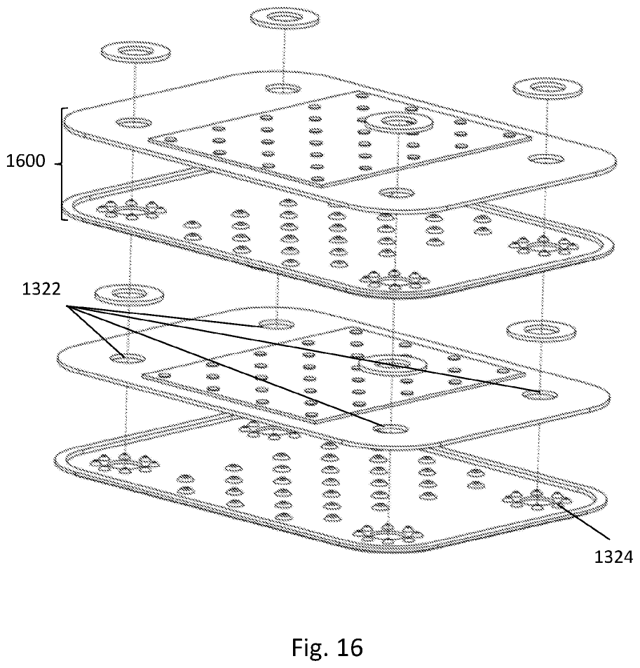

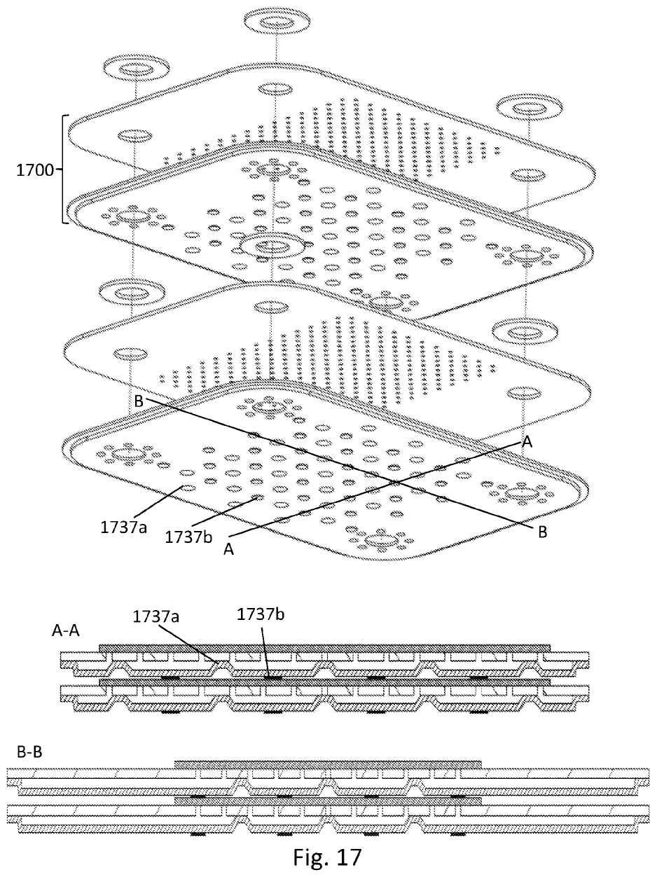

Although only two fluid ports 1322 are depicted, other numbers of fluid ports 1322 are possible. An example of the cell unit 1500 with four fluid ports 1322 is shown in FIG. 16, which is otherwise similar to the cell unit described with reference to FIG. 15.

Referring to FIG. 17, two example electrolyser cell units 1700 are shown in an exploded perspective view alongside cross-sections A-A and B-B through two electrolyser cell units in a stacked arrangement (note that the height direction in the cross-sections is exaggerated for clarity). The cell unit 1700 is similar to the cell unit 1600 of FIG. 16 save that the discrete protrusions 1737b are provided on the first side of the separator plate rather than on the outermost layer of the electrochemically active area. The discrete protrusions 1737b may be of similar materials and manufactured in similar ways as described with reference to the discrete protrusions 1537 on the outermost layer of the electrochemically active cell area. Dimples 1737a extend from the second side of the separator plate towards the first side of the cell layer (in this case the metal support plate) and are the same as the dimples 1536 described with reference to FIG. 15.

It will be noted that FIG. 17 is shown in a different perspective view to that of FIGS. 13B to 16 in order to view the discrete protrusions 1737b. This view also enables sight of the multiple holes (or pores) through the metal support plate and which are herein referred to collectively as the porous region, which allows fluidic communication between the first fluid flow region (first fluid volume) and the layer of the electrochemically active cell area closest to the metal support plate. This may be referred to as the porous region. Said porous region also being present in FIGS. 13B-16.

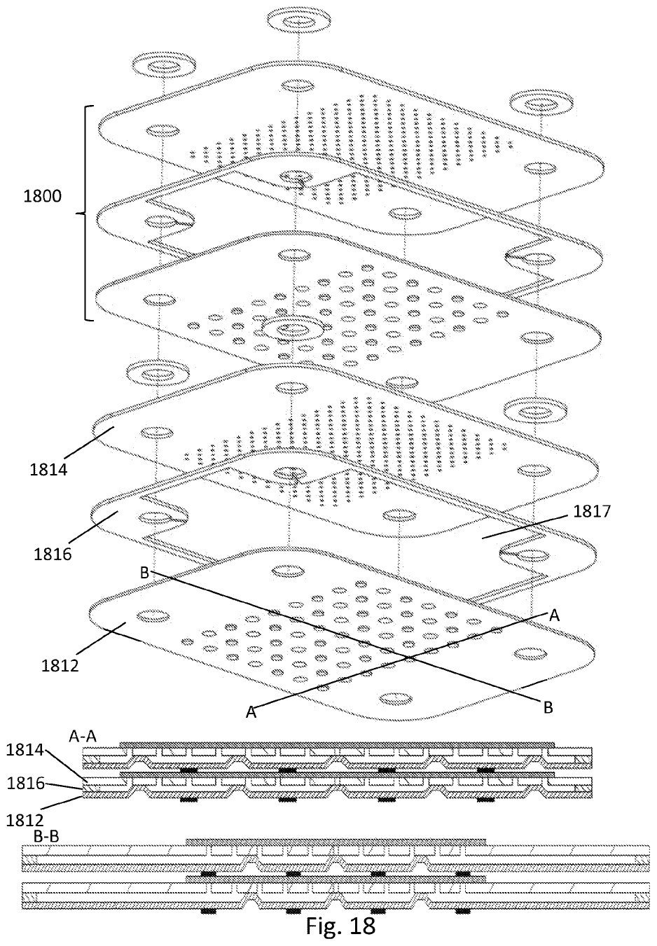

Referring to FIG. 18, two example electrolyser cell units 1800 are shown in an exploded perspective view alongside cross-sections A-A and B-B through two electrolyser cell units in a stacked arrangement (note that the height direction in the cross-sections is exaggerated for clarity). The cell unit 1800 is similar to the cell unit 1700 of FIG. 17 save that instead of the flange there is provided a spacer plate 1816 between the metal support plate 1814 and the separator plate 1812. The spacer plate 1816 may extend around the perimeter of the separator plate and/or the cell layer. It may serve to space the plates apart and define the first fluid volume. When the spacer plate 1816 is provided the separator plate 1812 may not be provided with the flange shown in the cell units 1300-1700 of FIGS. 13-17.

The spacer plate 1816, when in position in the cell unit overlies/underlies the perimeter of the separator plate 1812 and the perimeter of the metal support plate 1814. A central hollow portion 1817 of the spacer plate 1816 at least overlies/underlies the electrochemically active cell area, the dimpled protrusions, and the discrete protrusions. The hollow central portion 1817 also at least underlies the porous region (multiple small holes) provided in the metal support plate 1812 to enable fluid in the first fluid volume to be in fluidic communication with the side of the electrochemical layers that is closest to the metal support plate 1814. The hollow portion 1817 of the spacer plate 1816, when sandwiched between the separator plate 1812 and the metal support plate 1814, forms the first fluid volume between the separator plate 1812 and the metal support plate 1814. This fluid volume is typically used for fuel, such as steam. The spacer plate has fluid ports similar to those provided in the metal support plate and separator plate, however the ports in the spacer plate have throats for fluidic communication with the first fluid volume (i.e. to allow fluidic communication between the chimney formed by the aligned ports and gaskets and the first fluid volume, in a similar way—and in replacement for—the port features 1324).

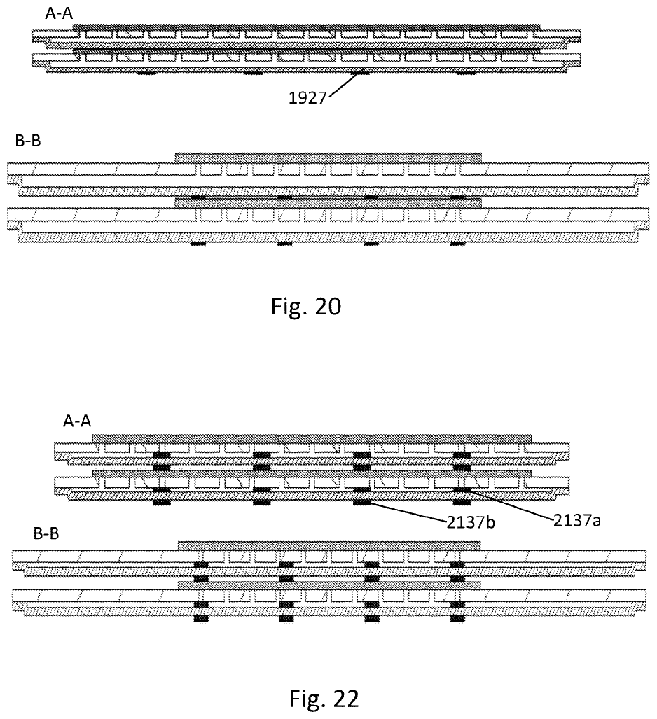

Referring to FIGS. 19A, 198, & 20, two example electrolyser cell units 1900 are shown in exploded perspective views of FIGS. 19A and 19B, alongside cross-sections A-A and B-B in FIG. 20 through two electrolyser cell units in a stacked arrangement (note that the height direction in the cross-sections is exaggerated for clarity). The cell unit 1900 is similar to the cell unit 1700 of FIG. 17 save the second side of the separator plate 1912 is clear of all dimpled protrusions (such as the dimpled protrusions 1436) or other pressed or formed features in a region that extends across at least the electrochemically active cell area such that fluid flow in the first fluid volume is unencumbered i.e. the fluid can flow freely over the second side of the separator plate 1912. In other words, that region is clear of (dimpled, e.g., pressed) protrusions directed toward the cell layer or other components to separate the separator plate from the cell layer. Instead of such (dimpled) protrusions 1436, the separator plate is adapted to be exposed to a pressure difference between the first side and the second side of the separator plate to maintain the spaced arrangement that forms the first fluid volume. The pressure of the gas in the first fluid (fuel) volume thus maintains the rigidity of the cell unit. In this regard, cell unit 1900 is adapted in a similar way and functions in a similar manner to that described with respect to FIGS. 3 to 9.

The first side of separator plate 1912 has discrete protrusions similar to, of similar materials and manufactured in similar ways as described with reference to the discrete protrusions 1737b.

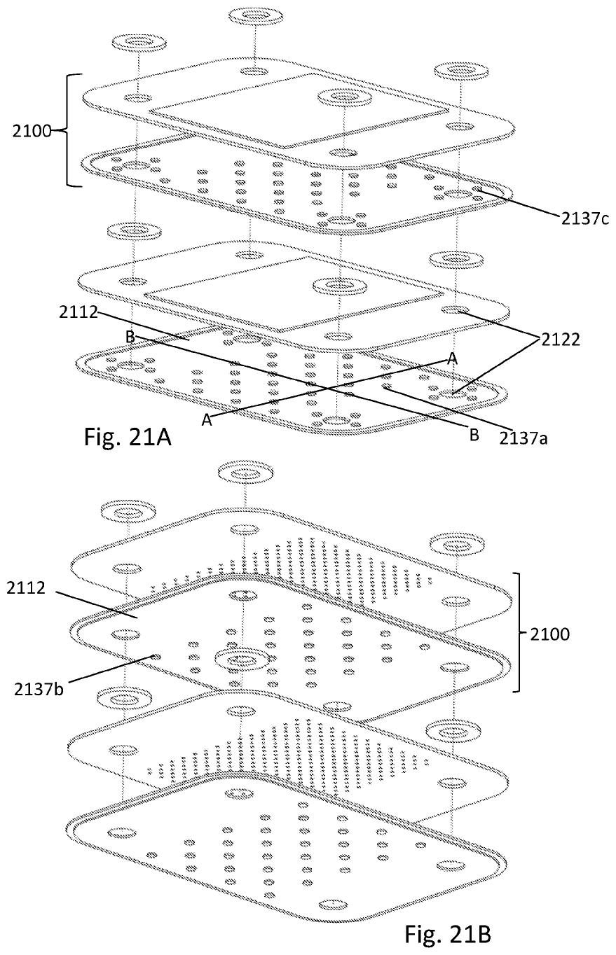

Referring to FIGS. 21A, 21B, & 22, two example electrolyser cell units 2100 are shown in exploded perspective views of FIGS. 21A and 21B, alongside cross-sections A-A and B-B in FIG. 22 through two electrolyser cell units in a stacked arrangement (note that the height direction in the cross-sections is exaggerated for clarity). The cell unit 2100 is similar to the cell unit 1700 of FIG. 17 save that the only pressed features in the separator plate 2112 is the flange. Discrete protrusions 2137b are provided on the first side of the separator plate and are similar to the discrete protrusions 1737b of FIG. 17 (i.e. they provide the second fluid flow region).

In addition, unlike in cell unit 1900, the second side of the separator plate 2112 of cell unit 2100 has discrete protrusions 2137a extending toward the metal support plate of the same cell unit. The discrete protrusions 2137a act to maintain the spaced arrangement between the first side of the separator plate 2112 and the metal support plate, and thereby provide the first fluid flow region in the first fluid volume. The discrete protrusions 2137a on the second side of the separator plate 2112 are similar in morphology, material, and method of manufacture to the discrete protrusions 2137b on the first side of the separator plate 2112. The discrete protrusions 2137a on the second side of the separator plate 2112 are provided instead of the dimpled protrusions 1436, 1536 described previously, obviating the need for pressing. Similarly, discrete protrusions 2137c are provided around the ports 2122 instead of pressed port features 1324, but act in a similar way-allowing fluid in/out of the fluid ports 2122 from/to the first fluid volume.

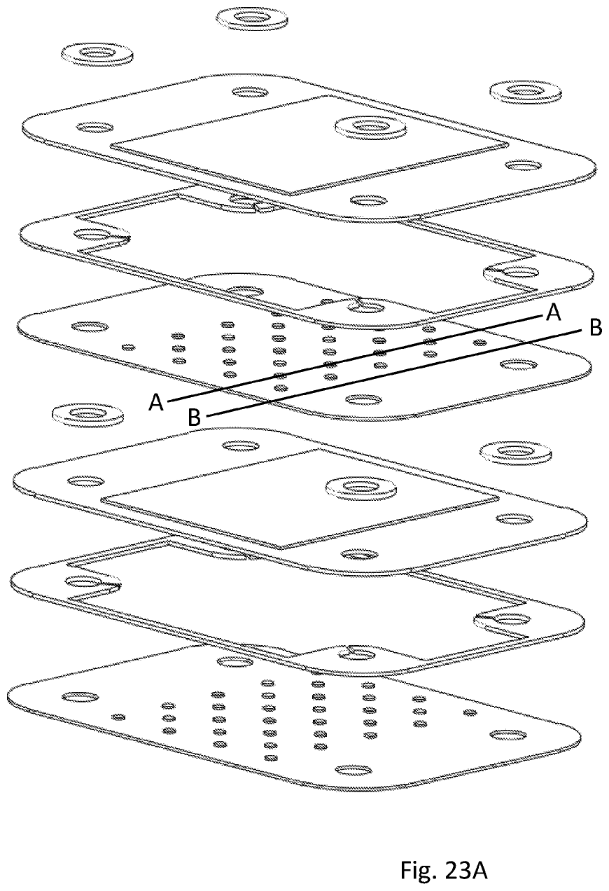

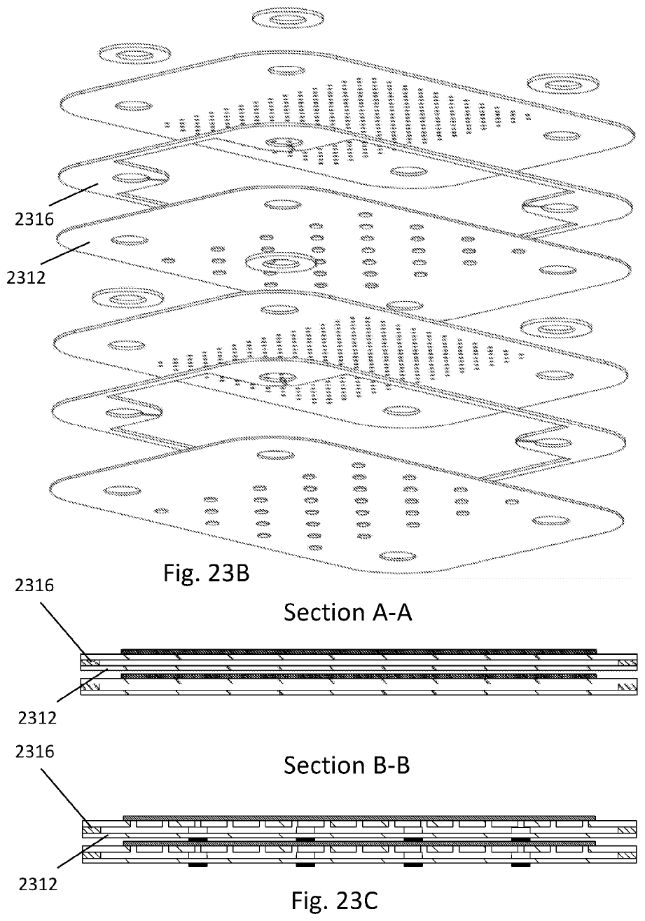

FIGS. 23A, 23B and 23C shows a cell unit 2300 which is similar to that of FIGS. 21A, 21B and 22 but the first fluid volume is enclosed by way of a spacer plate 2316 (similar to that of FIGS. 8, 9 and 18) instead of a flange formed on the separator plate 2312.

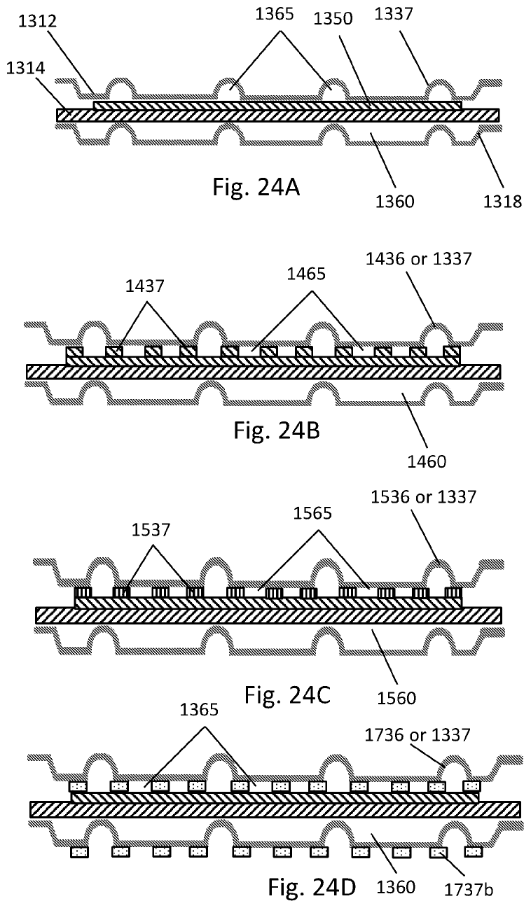

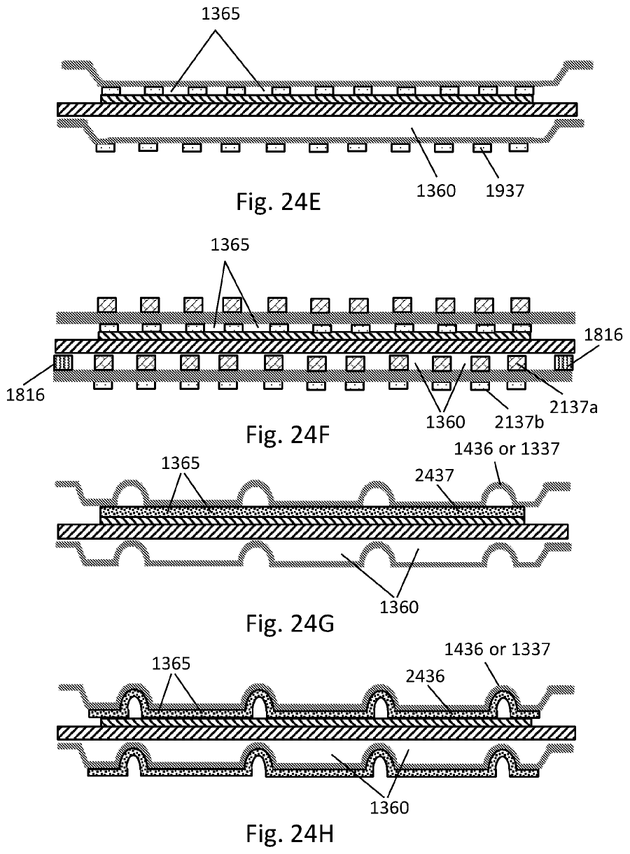

FIGS. 24A-24F show various simplified cross-sections corresponding to earlier figures. Table 1 below indicates the correspondence. It will be understood that the flanged perimeter, shown in FIGS. 24A-24E, 24G and 24H may be used instead of the spacer 1816 shown in FIG. 24F, and that a spacer as shown in FIG. 24F may be used instead of the flanged perimeter, shown in FIGS. 24A-24E, 24G and 24H. In some instances a flanged perimeter may be cheaper than using a spacer (particularly so when pressed or formed features are provided in the separator plate, which both may be formed or pressed in the same step). In some instances that may not be the case, and reliability of a cell unit utilising a spacer may be improved relative to one having a flanged perimeter, the pressing of which can introduce stresses.

FIGS. 24G and 24H do not correspond to earlier figures. These both utilise a ‘porous layer’ 2437, 2436 to form the second fluid flow region (and the second fluid volume) instead of any formations (discrete protrusions, linear protrusions, pressed ribs) on the electrochemically active cell area or interconnect. This layer may be applied to (e.g., coated on, affixed to, and/or supported by) the top of the electrochemically active cell area (porous layer 2437 of FIG. 24F) or to the bottom of the interconnect (porous layer 2436 of FIG. 24G).

Such a porous layer allows for the passage of second fluid (e.g., oxidant for an SOEC or hydrogen for a PEM electrolyser) and is electrically conductive.

In some examples, the porous material is an additional ceramic layer, optionally treated to increase its porosity. Such treatments include sintering, or by applying additives that that either burn out leaving a void or agents that “foam” the ceramic.

In another example, the porous layer is a metal mesh, preferably strips of metal mesh. Steel is a suitable material as it can withstand the temperatures inside an electrolyser and readily made into a mesh.

The thickness of the porous layer may be similar to that of the features (discrete protrusions, linear protrusions, pressed or formed ribs) discussed above, namely between 0.01-0.45 mm, preferably 0.05-0.25 mm, more preferably 0.1-0.2 mm or 0.1-0.15 mm or 0.15-0.2 mm.

The porous layer of FIG. 24G or 24H may also be used with a separator plate such as that of FIG. 24E or F in which there are no pressed/formed ribs 1337, dimples 1436, or discrete dimples 2137a.

Where the cell units described with respect to FIGS. 13 to 24 are electrolyser cell units (or arranged to form a stack of electrolyser cell units), and in a particular example when said cell units are solid oxide electrolyser cell units (or a stack thereof), a fuel (i.e. the cathode inlet gas eg., H₂O typically in the form of steam) enters, via an inlet port, the first fluid volume (fuel volume) between the separator plate and the cell layer (e.g., the metal support plate). In an example, a SOEC with H₂O as the fuel (the first fluid provided to the first fluid volume) combines with electrons flowing to the cathode electrode of the electrochemically active layer of the cell unit to produce oxygen ions and hydrogen gas. The hydrogen gas is exhausted out of the first fluid volume via a cathode outlet. The oxygen ions travel through the solid oxide electrolyte toward the anode (air side) of the electrochemically active layer. At the anode the oxygen ions combine via reduction with electrons to produce oxygen molecules which is subsequently exhausted out of the cell unit at an anode outlet. The redox reaction experienced in the solid oxide electrolyser is as follows:

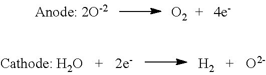

At the same time a sweep gas (e.g. oxidant such as air or oxygen (i.e. the anode inlet gas)) may be passed to the anode inlet of the cell unit to flow through the second fluid flow region (either side of separator plate and the metal support plate) in order to assist with extraction of species produced at the second side of the electrochemically active cell area.

The fuel and electrochemically-produced oxygen (plus any sweep gas) may flow in a co-flow configuration such that the fuel and the oxidant flow in the same direction across their respective sides of the cell unit. Alternatively, the fuel and electrochemically-produced oxygen (plus any sweep gas) may flow in counter or cross flow configuration.

Where the cell unit 1300; 1400; 1500 1600; 1700; 1800; 1900 is an electrolyser cell unit, the fuel may be provided to the first fluid volume of the electrolyser cell unit at a different pressure to that experienced in the second fluid volume to provide a pressure difference between the first and second sides of the separator plate (and, indeed, of the cell layer). By providing a pressure difference between the first side and the second side, a separation between (the second side of) the separator plate and (the first side of) the cell layer (first side of the metal support plate) can be controlled. For example the separation can be maintained or increased to create and/or maintain the first fluid volume by use of a higher pressure in the first fluid volume than in the second fluid volume.

To enable the separation between the separator plate 1312; 1412; 1512; 1612; 1712; 1812; 1912 and the cell layer (metal support plate 1314; 1414; 1514; 1614; 1714; 1814; 1914) to be maintained or increased through the provision of a pressure difference between the first side and the second side, the separator plate may be adapted, or configured, to flex when exposed to the pressure difference. For example, when exposed to the pressure difference the separator plate may flex away from the cell layer (or metal support plate) of the cell unit (and toward a neighbouring cell unit) as the pressure difference is increased i.e. the separator plate is adapted to flex away from the cell layer (or metal support plate) when exposed to the pressure difference as a positive function of the pressure difference. Adjustment of the pressure difference can adjust the contact resistance between the first side of the separator plate and the electrochemically active cell area of an adjacent cell unit (in particular, a higher pressure in the first fluid volume relative to the second fluid volume increases the contact force between the separator plate and the electrochemically active cell area of an adjacent cell unit thereby decreasing the contact resistance therebetween). In electrolysis operation, the fuel may be steam which is typically produced at relatively high pressures, therefore use of such high pressure steam is advantageous. Further, the second fluid flow region/second fluid volume may only be occupied by product of the electrolysis reaction (alternatively, that product plus a sweep gas), that is of lower pressure than the steam and having a lower volumetric flow requirement than the first fluid volume.

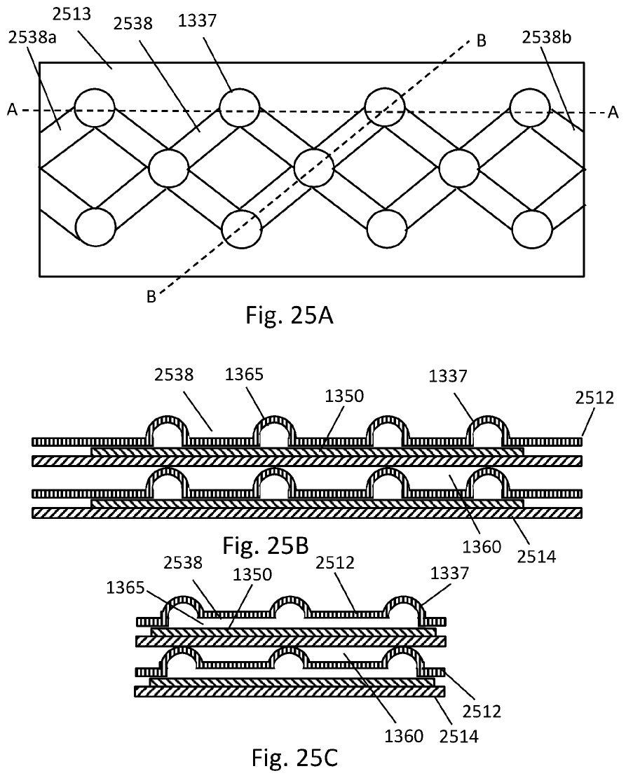

FIG. 25 shows a simplified cell unit 2500 which is similar to that of FIGS. 13B and 24A except that the separator plate 2512 is provided with both ribs 2538 and protrusions 1337. In this case, the ribs connect neighbouring protrusions. FIG. 25A is a simplified plan view showing a first side of a separator plate 2512 of the cell unit 2500. FIG. 25B is a cross-sectional view of two cell units 2500 along line A-A of FIG. 25a. FIG. 25C is a cross-sectional view of two cell units 2500 along line B-B of FIG. 25a. Protrusions 1337 protrude on the second side of the separator plate 2512 towards the first side of the cell layer 2514, and contact the first side of the cell layer 2514 (specifically contact the first side of the support plate). The ribs 2538 protrude on the second side of the separator plate towards the first side of the cell layer. In other words, the protrusions 1337 and ribs 2538 form a convex surface on the second side of the separator plate and a concave surface on the first side of the separator plate. However, the ribs 2538 do not contact the first side of the cell layer 2514. As a result, the protrusions 1337 define the height of the first fluid flow region 1360 while the ribs 2538 do not restrict fluid flow within the first fluid flow region. On the first side of the separator plate, the ribs 2538 fluidically connect protrusions 1337 (the concave sides of each) to form the second fluid flow region 1365. Each protrusion 1337 is connected to its nearest neighbours by corresponding ribs 2538, thereby forming a network of interconnected ribs. The network of interconnected ribs may include end ribs 2538a,b, which are fluidically connected to a protrusion 1337 at only one end. At their opposing end, the end ribs 2538a,b traverse past the end of the electrochemically active cell area 1350. As a result, second fluid may flow in the second fluid flow region defined by the network of interconnected ribs from or to the second side of the cell layer, via the end ribs 2538a,b, the ribs 2538, and the protrusions 1337. FIG. 25 depicts each protrusion being connected to its nearest neighbours by corresponding ribs (in this case, each protrusion has four nearest neighbours and one rib to each nearest neighbour). Other configurations may be used, for example ribs may be aligned with a length- or width-direction of the cell unit and connect dimples in that direction (in the simplified view of FIG. 25 this may result in three interconnected ribs traversing the cell unit from left to right). In this case, both the ribs 2538 (including the end ribs) an the protrusions 1337 are pressed or formed in the separator plate, said pressing/forming may be completed at the same step as creating other features (fluid ports, flanged perimeter) in the separator plate.

The above example embodiments disclose various arrangements of forming a second fluid volume which has a smaller cross-sectional area than the first volume. In general, this can be achieved by one or more of: features of the interconnect, features of the electrochemically active cell area, the presence of a separator plate, or a pressure differential.

The following table summarises the similarities/differences in the way the second volume is formed:

| | Second fluid flow region formed by . . . | | |
|---|---|---|---|
| FIG./ | | Electrochemically | |
| Embodiment | Separator plate | active cell area | Comment |
| 13B, 24A | Concave pressed ribs | NA | Same feature provides both fluid |
| | | | flow regions |
| 14, 24B | NA | Etched/ | Dimples provide first fluid flow |
| | | machined/ | region |
| | | deposited ribs | |
| 15/16, 24C | NA | Discrete | Dimples provide first fluid flow |
| | | protrusions | region |
| | | (dimples) | |
| 17, 24D | Discrete protrusions | NA | Dimples provide first fluid flow |
| | | | region |
| 18 | Discrete protrusions | NA | Spacer plate encloses first fluid flow |
| | | | region |
| 19, 20, 24E | Discrete protrusions | NA | Pressure difference maintains first |
| | | | fluid flow region |
| 21, 22 | Discrete protrusions | NA | Discrete protrusions provide first |
| | | | and second fluid flow regions |
| 23, 24F | Discrete protrusions | NA | Spacer plate encloses first fluid flow |
| | | | region |
| | | | Discrete protrusions provide first |
| | | | and second fluid flow regions |
| 24G | NA | Porous layer | Porous layer on electrochemically |
| | | | active cell area provides second fluid |
| | | | flow region |
| 24H | Porous layer | NA | Porous layer on separator plate |
| | | | provides second fluid flow region |
| 25 | Concave pressed ribs | NA | Same feature provides both fluid |
| | connecting protrusions | | flow regions |

Any of these embodiments of FIGS. 13-25 can be combined with any of the embodiments shown in FIGS. 2-9 which relate to the formation of the first volume. It should also be appreciated that a flange formed on the interconnect, or a spacer may be used to form the first volume.

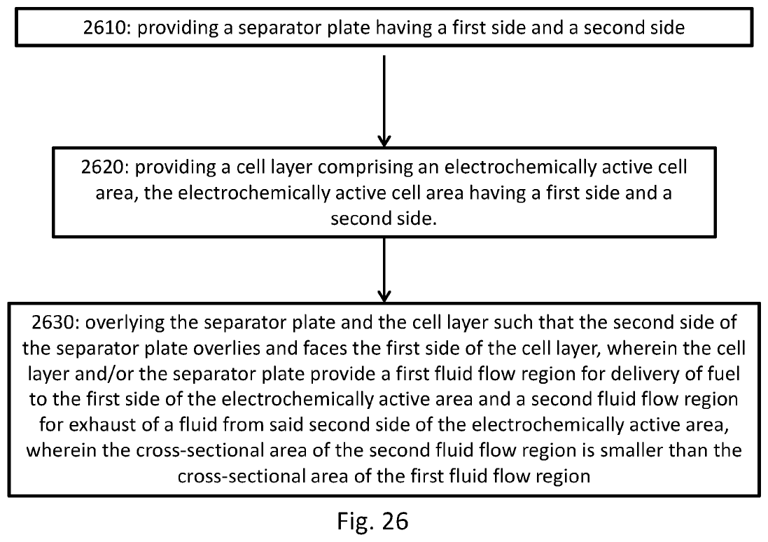

A method of manufacturing any of the cell units described with reference to FIGS. 13 to 25 includes a number of steps/operations as exemplified with reference to FIG. 26. That method includes the following steps.

At step 2610, a separator plate having a first side and a second side is provided. The separator plate may be produced by cutting or stamping. The separator plate may, for example, be a planar metal sheet that is non-porous, or any other planar sheet that is non-porous, and which acts to separate one cell unit from an adjacent cell unit in a stack. The separator plate may be provided with dimpled protrusions and/or a flange extending out of a plane of the separator plate, which may be provided by pressing/forming in the same step as the cutting/stamping.

Step 2610 also preferably involves providing a separator plate that has a flange. The flange extends out of the predominant plane of the separator plate. The flange creates a concavity in the separator plate (and a convexity to the outside surface). The concavity forms a first fluid volume 1360; 1460; 1560; 1660; 1760; 1960 within this cell unit upon assembly of the cell unit. The flange may be made by pressing the separator plate or the metal support plate (of the cell layer) respectively.

Alternative to the flange, a spacer plate 1816 may be provided and sandwiched between separator plate 1812 and metal support plate 1814 at step 2630 to form the first fluid volume therebetween.

At the same time as cutting or stamping the separator plate (to create ports, provide its shape and/or produce the flanged perimeter), the separator plate may also be provided with formed port features 1324, 1324, 1324, and/or ribs 1377 and/or dimpled protrusions 1436, 1536, 1737a.

Additionally, where appropriate the separator plate may be provided with discrete protrusions 1737b, 1937, 2137b on the first side of the separator plate and/or with discrete protrusions 2137a on the second side of the separator plate. The discrete protrusions may be provided subsequent to the cutting/stamping/pressing/forming step to remove possibility of damage during the same, or may be provided prior to said step such that they are provided on a planar sheet. Said discrete protrusions may be manufactured by first depositing a homogeneous layer of material on the separator plate and subsequently etching (after application of a suitable mask) or machining away excess material to form the discrete protrusions, or by screen or inkjet printing of said discrete protrusions. The discrete protrusions may be a ceramic or other material.

The separator plate may be provided with a second fluid flow region on the second side of said separator plate. Such a fluid flow region is configured to deliver and control the flow of second fluid to the outermost layer of the electrochemically active region. Providing the second fluid flow region may include printing or depositing a material to form the fluid flow region on the first side of the separator plate. Alternatively, or additionally, providing the second fluid flow region may include printing or depositing a homogeneous layer on the first side of the separator plate, and selectively removing material from that layer to form the second fluid flow region. Said selectively removing may involve etching (having applied a suitable mask) or otherwise machining material to form the second fluid flow region.

At step 2620, a cell layer is provided. That cell layer comprising an electrochemically active cell area, the electrochemically active cell area having a first side and a second side. This may involve providing a metal support comprising an electrochemically active cell area which includes an anode, a cathode, and an electrolyte positioned between the anode and cathode. The metal support plate has a first side and a second side, typically with a central porous region which may be formed by providing a plurality of through holes from the first side to the second side of the metal support plate. Providing the cell layer may include coating the electrochemically active cell area on a planar metal sheet e.g. by depositing or printing the electrochemically active cell area on the metal support plate, thus forming a metal supported cell layer. Said porous region provides fluidic communication from the first side to the electrode supported by the metal support plate on its second side. Alternatively, the cell layer may support itself. In such cases, the cell layer has an anode-supported, electrolyte-supported, or cathode-supported architecture.

Step 2620 may also involve providing the second fluid flow region within or on the electrochemically active cell area (of the cell layer, which may be supported by the metal support plate). Such a fluid flow region is configured to deliver and control the flow of second fluid to the outermost layer of the electrochemically active cell area. Providing the second fluid flow region may include printing or depositing a material to form the fluid flow region on an outermost layer of the electrochemically active cell area. Said printing or depositing may create the discrete protrusions and/or ribs in one step. Alternatively or additionally, said printing or deposition may be of a homogeneous layer, and providing the second fluid flow region further involves selectively removing material from that layer to form the second fluid flow region. Alternatively, or additionally, providing the second fluid flow region may include selectively removing material from the outermost layer of the electrochemically active region to form the second fluid flow region. Said selectively removing may involve etching (having applied a suitable mask) or otherwise machining material to form the second fluid flow region.

The second fluid flow region may be in the form of ribs or discrete protrusions as previously described, and may be formed of a ceramic or other material.

Step 2610 and step 2620 also include providing a plurality of fluid ports 1332; 1432; 1532; 1632; 1732; 1832; 1932 in both of the separator plate and the metal support plate (and in the spacer plate, with throats, as appropriate) to allow for the flow of a fluid (such as steam) through the cell units (and ultimately through a stack of cell units) to provide fuel to each cell unit, in particular to provide fuel to the first fluid volume of each cell unit.

At step 2630, the separator plate and the cell layer are overlaid (with the spacer plate therebetween, or with at least one of the separator plate and cell layer having a flange) such that the second side of the separator plate underlies and faces the first side of the cell layer, wherein the cell layer and/or the separator plate provide a first fluid flow region for delivery of fuel to the first side of the electrochemically active area and a second fluid flow region for exhaust of a fluid from said second side of the electrochemically active area, wherein the cross-sectional area of the second fluid flow region is smaller than the cross-sectional area of the first fluid flow region. At step 2630, the separator plate and the cell layer are overlaid so that the second fluid flow region is orientated to point away from the first fluid volume toward an adjacent cell unit when the cell unit is placed in a stack arrangement. That second fluid flow region not being created by dimpled protrusions or ribs formed or pressed into the separator plate.

At step 2630, the separator plate and the cell layer may be overlaid in a spaced arrangement so that the first fluid flow region is created therebetween. The separator plate may be configured with no dimpled protrusions which protrude from the second side thereof into the first fluid volume/towards the cell layer. In other words there is a continuous region that extends across at least the electrochemically active cell area that is clear of protrusions directed toward the cell layer (metal support plate)/out of the second side of the separator plate. It is also clear of any other component which is configured to resist a stack compression force and transfer such force to the protrusions which connect adjacent cell units. Thus there is no component within the first fluid volume, between the separator plate and cell layer, to assist (in particular in operation) in the physical separation of them from one another.

When formed, a cross-sectional area of the first fluid volume (also known as a first fluid flow region) of the electrolyser cell unit is greater than the cross-sectional area of the second fluid volume (also known as a second flow region).

At step 2630 the separator plate and metal support plate may be directly adjoined (and sealingly adjoined) at the flange described above to form the first fluid volume therebetween. The separator plate and metal support plate may be directly adjoined optionally by welding.

In the alternative arrangement without the flange, a spacer plate is provided and sandwiched between the separator plate and metal support plate to form the first fluid volume therebetween, and at 2630 those three plates are sealingly fixed to one another, for example by welding around their periphery (and through the three plates).

The method may further include forming a stack of electrolyser cell units by providing a plurality of cell units in accordance with the above and overlaying a second cell unit upon a first cell unit (and so on, to form a stack having a given number of cell units).

As discussed above, each cell unit may include a separator plate and a cell layer, the second side of the separator plate overlaying and facing, in a spaced arrangement (thereby creating the first fluid flow region), the first side of the cell layer. In such a case, overlaying the second cell unit upon the first cell unit involves overlaying the first side of the separator plate of the second cell unit facing the second side of the cell layer of the first cell unit (thereby creating the second fluid flow region).

Alternatively, and as also discussed above, each cell unit may include a separator plate and a cell layer, the first side of the separator plate overlaying and facing, in a spaced arrangement (thereby creating the second fluid flow region), the second side of the cell layer. In such a case, overlaying the second cell unit upon the first cell unit involves overlaying the second side of the separator plate of the first cell unit facing the first side of the cell layer of the second cell unit (thereby creating the first fluid flow region).

When forming the stack, a plurality of gaskets is provided between neighbouring cell units, one gasket corresponding to each of the plurality of fluid ports of the cell units.

A method of operating a stack of electrolyser cell units is next described. The method includes providing fuel (e.g., fuel for electrolysis) to the first fluid flow region, the first fluid flow region for delivery of fuel to a first side of an electrochemically active cell area and the first fluid flow region defined by a spaced arrangement between the first side of the electrochemically active cell area and a second side of an adjacent separator plate. The method further includes exhausting a second fluid (e.g., a product of the electrolysis reaction) from the second fluid flow region. The second fluid flow region for exhaust of the fluid from a second side of the electrochemically active cell area. The second fluid flow region may be defined between a second side of the cell layer and a first side of an adjacent separator plate. The method may further include controlling the flow rate of fluid in the first fluid flow region at a flow rate at least twice the flow rate of fluid in the second fluid flow region.

A sweep gas may be provided to the second fluid flow region, wherein the controlling is further configured to control the flow rate of fuel provided to the first fluid flow region to be at least three times, optionally five times, the flow rate of sweep gas provided to the second fluid flow region.

The method may further include (as part of the controlling or alternate thereto) regulating a pressure difference between the first fluid flow region and the second fluid flow region to maintain a spaced arrangement between a cell layer and separator plate that forms the first fluid flow region (and first fluid volume).

The pressure difference between the first fluid flow region (first fluid volume) and the second fluid flow region (second fluid volume) may be regulated to be in the range of 50 mbar to 2 bar, preferably between 100 mbar to 1.5 bar, more preferably 200 mbar to 800 mbar. The pressure difference between the first fluid volume and the second fluid volume may be regulated to decrease an electrical contact resistance between the separator plate and the electrochemically active cell area of the second, neighbouring, cell unit in the stack of cell units.

The present invention is not limited to the above examples only, and other examples will be readily apparent to one of ordinary skill in the art without departing from the scope of the appended claims.

These and other features of the present invention have been described above purely by way of example. Modifications in detail may be made to the invention within the scope of the claims.

1. An electrolyser cell unit comprising:
a cell layer comprising an electrochemically active cell area, the cell layer having a first side and a second side;
a first fluid flow region for delivery of fuel to the first side of the cell layer; and
a second fluid flow region for exhaust of a fluid from said second side of the cell layer, wherein the cross-sectional area of the second fluid flow region is smaller than the cross-sectional area of the first fluid flow region.

2. The electrolyser cell unit of claim 1, further comprising:
a separator plate having a first side and a second side, the second side of the separator plate overlying and facing the first side of the cell layer in a spaced arrangement to form the first fluid flow region.

3. The electrolyser cell unit of claim 2, wherein the second fluid flow region is defined by a region between the second side of the cell layer and a first side of a separator plate of an adjacent electrolyser cell unit.

4. The electrolyser cell unit of claim 1, further comprising a separator plate having a first side and a second side, the first side of the separator plate overlying and facing the second side of the cell layer in a spaced arrangement to form the second fluid flow region; wherein the first fluid flow region is defined by a region between the first side of the cell layer and a second side of a separator plate of an adjacent electrolyser cell unit.

5-9. (canceled)

10. The electrolyser cell unit of claim 2, wherein the separator plate has a region that overlies at least part of the electrochemically active cell area that is planar and that region having no pressed or formed protrusions directed away from the first side of the cell layer.

11. The electrolyser cell unit claim 2, wherein the separator plate has a region that overlies at least part of the electrochemically active cell area that is provided with a plurality of pressed or formed protrusions directed toward the first side of the cell layer to form the first fluid flow region, those pressed or formed protrusions outwardly extend from the second side of the separator plate, thereby forming convex protrusions on said second side of the separator plate and concave depressions on the first side of the separator plate.

12. The electrolyser cell unit of claim 2, wherein the separator plate is provided with a plurality of pressed or formed ribs extending from the second side of the separator plate toward the first side of the cell layer to form the first fluid flow region, wherein the corresponding concave side of each rib forms a channel on the first side of the separator plate to form the second fluid flow region.

13. The electrolyser cell unit of claim 12, wherein the separator plate has a region that overlies at least part of the electrochemically active cell area that is provided with a plurality of pressed or formed protrusions directed toward the first side of the cell layer, and the concave side of each rib fluidically connects the protrusions, the ribs and the protrusions thereby form the second fluid flow region.

14. The electrolyser cell unit of claim 13, wherein the protrusions are adapted to contact the first side of the cell layer and the ribs are not adapted to contact the first side of the cell layer.

15. The electrolyser cell unit of claim 2, wherein the separator plate has a region that extends across at least the electrochemically active cell area, and wherein the region is clear of protrusions directed toward the cell layer or other components to separate the separator plate from the cell layer; and wherein the separator plate is adapted to be exposed to a pressure difference between the first side and the second side of the separator plate to maintain the spaced arrangement that forms the first fluid flow region.

16-17. (canceled)

18. The electrolyser cell unit of claim 1, wherein the second side of the separator plate comprises features deposited thereon to form the first fluid flow region.

19-20. (canceled)

21. The electrolyser cell unit of claim 1, wherein the second fluid flow region is defined by the topology of a layer on the second side of the cell layer.

22. (canceled)

23. The electrolyser cell unit of claim 21, wherein the topology of the layer on the second side of the cell layer comprises features deposited thereon or formed therein to form the second fluid flow region.

24-25. (canceled)

26. The electrolyser cell unit of claim 1, wherein a ratio between the cross-sectional area of the second flow region and the cross-sectional area of the first flow region is 1:3 or lower, optionally 1:10 or lower.

27. The electrolyser cell unit of claim 1, wherein a height of the second fluid flow region is smaller than a height of the first fluid flow region, preferably at least 3, more preferably at least 10, times smaller than the height of the first fluid flow region.

28-29. (canceled)

30. The electrolyser cell unit of claim 1, wherein the electrochemically active cell area comprises an oxygen ion conducting electrolyte and the second fluid flow region is for exhaust of oxygen from the second side of the cell layer.

31-37. (canceled)

38. A method for manufacturing an electrolyser cell unit comprising:
providing a separator plate having a first side and a second side;
providing a cell layer comprising an electrochemically active cell area, the cell layer having a first side and a second side; and
overlying the separator plate and the cell layer such that the second side of the separator plate overlies and faces the first side of the cell layer, wherein the cell layer and/or the separator plate provide a first fluid flow region for delivery of fuel to the first side of the cell layer and a second fluid flow region for exhaust of a fluid from said second side of the cell layer, wherein the cross-sectional area of the second fluid flow region is smaller than the cross-sectional area of the first fluid flow region.

39-40. (canceled)

41. A method of operating an electrolyser cell unit comprising
providing a fuel to a first fluid flow region for delivery of fuel to a first side of an electrochemically active cell area;
exhausting a fluid from a second fluid flow region for exhaust of the fluid from a second side of the electrochemically active cell area; and
controlling the flow rate of fluid in the first fluid flow region at a flow rate at least twice the flow rate of fluid in the second fluid flow region.

42. The method of claim 41, further comprising providing a sweep gas to the second fluid flow region, wherein the controlling is further configured to control the flow rate of fuel provided to the first fluid flow region to be at least three times, optionally five times, the flow rate of sweep gas provided to the second fluid flow region.

43. The method of claim 41, wherein the controlling is further configured to regulate a pressure difference between the first fluid flow region and the second fluid flow region to maintain a spaced arrangement between a cell layer and separator plate that forms the first fluid volume, and wherein the pressure difference between the first fluid flow region and the second fluid flow region is regulated to be in the range of 50 mbar to 2 bar, preferably between 100 mbar to 1.5 bar, more preferably 200 mbar to 800 mbar.

44. (canceled)
